(19) United States
(12) Patent Application Publication
(10) Pub. No.: US 2025/0203426 A1
(43) Pub. Date: Jun. 19, 2025

(54) Reporting of NTN-Related SON Information

(71) Applicant: Telefonaktiebolaget LM Ericsson (publ), Stockholm (SE)

(72) Inventors: Marco Belleschi, Solna (SE); Pradeepa Ramachandra, Linköping (SE); Johan Rune, Lidingö (SE); Helka-Liina Määttänen, Espoo (FI)

(21) Appl. No.: 18/726,847

(22) PCT Filed: Jan. 11, 2023
(86) PCT No.: PCT/SE2023/050029

§ 371 Date: Jul. 5, 2024

Related U.S. Application Data
(60) Provisional application No. 63/298,280, filed on Jan. 11, 2022.

(51) Int. Cl. H04W 24/10; H04W 36/30

(52) U.S. Cl. CPC H04W 24/10; H04W 36/305

(57) ABSTRACT

Reporting of events in non-terrestrial network, NTN, coverage. An example method, in a wireless device operating in a wireless communication network, comprises detecting (310) one of one or more pre-determined triggering events and, responsive to the detected triggering event, determining (320) whether the triggering event occurred while the wireless device was operating under non-terrestrial network coverage or under terrestrial network coverage, and/or determining whether the triggering event was due to wireless device mobility or non-terrestrial network cell mobility. The method further comprises saving (330), for reporting to the wireless communication network, information corresponding to this determining.

### TECHNICAL FIELD

The present disclosure is generally related to wireless communication networks and is more particularly related to self-organizing wireless communication networks that include non-terrestrial networks (NTNs).

### BACKGROUND

### NTN

There is an ongoing resurgence of satellite communications. Several plans for satellite networks have been announced in the past few years. Satellite networks could complement mobile networks on the ground by providing connectivity to underserved areas and multicast/broadcast services.

To benefit from the strong mobile ecosystem and economy of scale, adapting the terrestrial wireless access technologies, including LTE and NR, for satellite networks is drawing significant interest, which has been reflected in the 3GPP standardization work.

In Release 15, 3GPP started the work to prepare NR for operation in a Non-Terrestrial Network (NTN). The work was performed within the study item “NR to support Non-Terrestrial Networks” and resulted in 3GPP TR 38.811. In Release 16, the work to prepare NR for operation in an NTN network continued with the study item “Solutions for NR to support Non-Terrestrial Network.” In parallel, the interest to adapt NB-IoT and LTE-M for operation in NTN is growing. Consequently, 3GPP Release 17 contains both a work item on NR NTN and a study item on NB-IoT and LTE-M support for NTN.

A satellite network or satellite-based mobile network may also be called a non-terrestrial network (NTN). Likewise, a mobile network with base stations on the group may also be called as terrestrial network (TN) or non-NTN network. A satellite within NTN may be referred to as an NTN node, NTN satellite, satellite node or simply a satellite.

A satellite radio access network usually includes the following components:
A satellite that refers to a space-borne platform.
An earth-based gateway that connects the satellite to a base station or a core network, depending on the choice of architecture.
Feeder link that refers to the link between a gateway and a satellite
Access link that refers to the link between a satellite and a UE.

Depending on the orbit altitude, a satellite may be categorized as low earth orbit (LEO), medium earth orbit (MEO), or geostationary earth orbit (GEO) satellite:
LEO: typical heights ranging from 250-1,500 km, with orbital periods ranging from 90-120 minutes.
MEO: typical heights ranging from 5,000-25,000 km, with orbital periods ranging from 3-15 hours.
GEO: height at about 35,786 km, with an orbital period of 24 hours.

The orbit heights for these satellites mean that satellite systems are characterized by a path loss that is significantly higher than what is expected in terrestrial networks. To overcome the pathloss it is often required that the access and feeder links are operated in line-of-sight conditions and that the UE is equipped with an antenna offering high beam directivity.

A communication satellite typically generates several beams over a given area. The footprint of a beam is usually in an elliptic shape, which has been traditionally considered as a cell. The footprint of a beam is also often referred to as a spotbeam. The spotbeam may move over the earth surface with the satellite movement or may be earth fixed with some beam pointing mechanism used by the satellite to compensate for its motion. The former is referred to as a moving cells (or moving beams) deployment scenario, while the latter is referred to as a quasi-earth-fixed cells (or quasi-earth-fixed beams) deployment scenario. The size of a spotbeam depends on the system design, which may range from tens of kilometers to a few thousands of kilometers. FIG. 1 shows an example architecture of a satellite network with bent pipe transponders.

In comparison to the beams observed in a terrestrial network, an NTN beam may be very wide and cover an area outside of the area defined by the served cell. Beams covering adjacent cells will overlap and cause significant levels of intercell interference. To overcome the large levels of interference, a typical approach is for the NTN to configure different cells with different carrier frequencies and polarization modes.

Propagation delay is an important aspect of satellite communications that is different from the delay expected in a terrestrial mobile system. For a bent pipe satellite network, the round-trip delay may, depending on the orbit height, range from tens of milliseconds in the case of LEO satellites to several hundreds of milliseconds for GEO satellites. As a comparison, the round-trip delays in terrestrial cellular networks are typically below 1 millisecond.

The distance between the UE and a satellite can vary significantly, depending on the position of the satellite and thus the elevation angle ε seen by the UE. Assuming circular orbits, the minimum distance is realized when the satellite is directly above the UE (ε=90°), and the maximum distance when the satellite is at the smallest possible elevation angle. Table 1 shows the distances between satellite and UE for different orbital heights and elevation angles, together with the one-way propagation delay and the maximum propagation delay difference (the difference from the propagation delay at ε=90°). Note that this table assumes a regenerative payload architecture. For the transparent payload case, the propagation delay between gateway and satellite needs to be considered as well, unless the base station corrects for that.

TABLE 1
Propagation delay for different orbital heights and elevation angles.

| | | Distance | One-way | Propagation |
|---|---|---|---|---|
| Orbital | Elevation | UE <-> | propagation | delay |
| height | angle | satellite | delay | difference |
| 600 km | 90° | 600 km | 2.0 ms | — |
| | 30° | 1075 km | 3.6 ms | 1.6 ms |
| | 10° | 1932 km | 6.4 ms | 4.4 ms |
| 1200 km | 90° | 1200 km | 4.0 ms | — |
| | 30° | 1999 km | 6.7 ms | 2.7 ms |
| | 10° | 3131 km | 10.4 ms | 6.4 ms |
| 35786 km | 90° | 35786 km | 119.4 ms | — |
| | 30° | 38609 km | 128.8 ms | 9.4 ms |
| | 10° | 40581 km | 135.4 ms | 16.0 ms |

The propagation delay may also be highly variable due to the high velocity of the LEO and MEO satellites and change in the order of 10-100 μs every second, depending on the orbit altitude and satellite velocity.

To handle the timing and frequency synchronization in a NR or LTE based NTN, a promising technique is to equip each device with a Global Navigation Satellite System (GNSS) receiver. The GNSS receiver allows a device to estimate its geographical position. In one example, an NTN gNB carried by a satellite broadcasts its ephemeris data (i.e., data that informs the UE about the satellite's position, velocity and orbit) to a GNSS-equipped UE. The UE can then determine the propagation delay, the delay variation rate, the Doppler shift and its variation rate based on its own location (obtained through GNSS measurements) and the satellite location and movement (derived from the ephemeris data).

The GNSS receiver also allows a device to determine a time reference (e.g., in terms of Coordinated Universal Time (UTC)) and frequency reference. This can also be used to handle the timing and frequency synchronization in a NR or LTE based NTN. In a second example, an NTN gNB carried by a satellite broadcasts its timing (e.g., in terms of a Coordinated Universal Time (UTC) timestamp) to a GNSS-equipped UE. The UE can then determine the propagation delay, the delay variation rate, the Doppler shift and its variation rate based on its time/frequency reference (obtained through GNSS measurements) and the satellite timing and transmit frequency.

The UE may use this knowledge to compensate its uplink transmissions for the propagation delay and Doppler effect.

The 3GPP release 17 study item on NB-IoT and LTE-M for NTN supports this observation “GNSS capability in the UE is taken as a working assumption in this study for both NB-IoT and eMTC devices. With this assumption, UE can estimate and pre-compensate timing and frequency offset with sufficient accuracy for UL transmission. Simultaneous GNSS and NTN NB-IoT/eMTC operation is not assumed.”

Furthermore, in the NTN work item and IoT NTN study item for 3GPP release 17, GNSS capability is assumed, i.e., it is assumed that an NTN-capable UE also is GNSS-capable and GNSS measurements at the UEs are essential for the operation of the NTN.

### Mobility in NTN

One characteristic of NTN is that the mobility framework, including procedures and channel measurements, is not only influenced by the UE mobility but also by cell mobility. In fact, the satellite is moving, and its provided network coverage may vary overtime. In a moving-cells deployment, the cells move across the surface of the earth, following the serving satellite's movement in its orbit. In a quasi-earth-fixed-cells deployment, each cell is more or less fixed to a certain geographical area, but (except in the GEO case) the satellite serving the cell will change, and when the satellite serving the cell in a given geographical area changes from one satellite to another the cell nominally changes too. For example, the Physical Cell Identifier (PCI) changes even though the new cell covers the same geographical area as the old one.

To tackle this issue, different enhancements have been discussed in 3GPP. For example, at least in the quasi-earth-fixed cells case, the UE may be configured by the network with an “end of service time” for the serving cell, which indicates when the current cell will stop serving the geographical area (i.e., when the current serving cell essentially will disappear), and which depends on evaluation by the network of how long the coverage can be guaranteed by the satellite hosting that cell. In this way, when the UE is approaching this “end of service time”, this may trigger a handover of the UE to the new cell that will replace the old cell, serving the same geographical area. This configuration can be provided as broadcast system information or as part of a conditional handover (CHO) configuration. The “end of service time” may also be referred to as the “service end time,” “service stop time,” or “Tservice.” The service end time may be configured in the form of an absolute time, e.g., UTC, or a timer indicating the time until the cell will stop serving the area.

Furthermore, when an old quasi-earth-fixed cell is switched to a new one covering the same geographical area, all the UEs connected in the old cell must be handed over to the new cell. This will potentially require a lot of handover signaling in a short time, even if a duration of overlap between the old and the new cell can (preferably) be provided (i.e., a transient time period during which the old and the new cell exist and cover the same geographical area in parallel). To mitigate this, 3GPP has introduced the possibility to configure conditional handover (CHO) with a time-based execution condition (combined with a channel quality condition). Two points in time, T1 and T2 are configured in the CHO configuration (where T1 is defined as a UTC timestamp and T2 is defined as a timer, or difference, in relation to T1), wherein the UE is allowed to execute the CHO between T1 and T2.

### Self-Organizing Networks (SON) in 3GPP

A Self-Organizing Network (SON) is an automation technology designed to make the planning, configuration, management, optimization, and healing of mobile radio access networks simpler and faster. SON functionality and behavior has been defined and specified in generally accepted mobile industry recommendations produced by organizations such as 3GPP (3rd Generation Partnership Project) and the NGMN (Next Generation Mobile Networks).

In 3GPP, the processes within the SON area are classified into a Self-configuration process and a Self-optimization process. Self-configuration process is the process where newly deployed nodes are configured by automatic installation procedures to get the necessary basic configuration for system operation.

This process works in the pre-operational state. Pre-operational state is understood as the state from when the eNB is powered up and has backbone connectivity until the eNB's radio frequency (RF) transmitter is switched on. As illustrated in FIG. 2, functions handled in the pre-operational state like Basic Setup and Initial Radio Configuration are covered by the Self Configuration process.

Self-optimization process is defined as the process where UE and access node measurements and performance measurements are used to auto-tune the network. This process works in operational state. Operational state is understood as the state where the RF interface is additionally switched on. As seen in FIG. 2, functions handled in the operational state like Optimization/Adaptation are covered by the Self Optimization process.

In LTE, support for Self-Configuration and Self-Optimization is specified, as described in 3GPP TS 36.300 section 22.2, including features such as Dynamic configuration, Automatic Neighbor Relation (ANR), Mobility load balancing, Mobility Robustness Optimization (MRO), RACH optimization and support for energy saving.

In NR, support for Self-Configuration and Self-Optimization is specified as well, starting with Self-Configuration features such as Dynamic configuration, Automatic Neighbor Relation (ANR) in Rel-15, as described in 3GPP TS 38.300 section 15.

### Mobility Robustness Optimization (MRO) in 3GPP

Seamless handovers are a key feature of 3GPP technologies. Successful handovers ensure that the UE moves around in the coverage area of different cells without causing too many interruptions in the data transmission. However, there will be scenarios when the network fails to handover the UE to the ‘correct’ neighbor cell in time and in such scenarios the UE will declare a radio link failure (RLF) or Handover Failure (HOF).

Upon HOF and RLF, the UE may take autonomous actions, i.e., trying to select a cell and initiate reestablishment procedure in an attempt to get back as soon as it can, so that it can be reachable again. An RLF in particular will cause a poor user experience, as the RLF is declared by the UE only when it realizes that there is no reliable communication channel (radio link) available between itself and the network. In any case, reestablishing the connection requires signaling with the newly selected cell (random access procedure, RRC Reestablishment Request, RRC Reestablishment RRC Reestablishment Complete, RRC Reconfiguration and RRC Reconfiguration Complete) and adds some latency, until the UE can exchange data with the network again.

According to 3GPP specifications (3GPP TS 36.331), possible causes for the radio link failure could be one of the following:
1) Expiry of the radio link monitoring related timer T310;
2) Expiry of the measurement reporting associated timer T312 (not receiving the handover command from the network within this timer's duration despite sending the measurement report when T310 was running);
3) Upon reaching the maximum number of RLC retransmissions;
4) Upon receiving random access problem indication from the MAC entity.

Since RLF leads to reestablishment which degrades performance and user experience, it is in the interest of the network to understand the reasons for RLF and try to optimize mobility-related parameters (e.g., trigger conditions of measurement reports) to avoid later RLFs. Before the standardization of MRO-related report handling in the network, only the UE was aware of some information regarding the radio quality at the time of RLF, the actual reason for declaring RLF, etc. For the network to identify the reason for the RLF, the network needs more information, both from the UE and from the neighboring base stations.

As part of the MRO solution in LTE, the RLF reporting procedure was introduced in the RRC specification in Release 9 RAN2 work. That has impacted the RRC specifications (3GPP TS 36.331) in that it was standardized that the UE would log relevant information at the moment of an RLF and later report that information to a target cell to which the UE successfully connects (e.g., after reestablishment). That has also impacted the inter-gNodeB interface, i.e., X2AP specifications (3GPP TS 36.423), as an eNB receiving an RLF report could forward the report to the eNB where the failure originated.

The contents of the RLF report generated by the UE have been enhanced with more details in the subsequent releases. The measurements included in the measurement report based on the latest LTE RRC specification are:
1) Measurement quantities (RSRP, RSRQ) of the last serving cell (PCell).
2) Measurement quantities of the neighbor cells in different frequencies of different RATs (EUTRA, UTRA, GERAN, CDMA2000).
3) Measurement quantity (RSSI) associated to WLAN Aps.
4) Measurement quantity (RSSI) associated to Bluetooth beacons.
5) Location information, if available (including location coordinates and velocity)
6) Globally unique identity of the last serving cell, if available, otherwise the PCI and the carrier frequency of the last serving cell.
7) Tracking area code of the PCell.
8) Time elapsed since the last reception of the ‘Handover command’ message.
9)C-RNTI used in the previous serving cell.
10) Whether or not the UE was configured with a DRB having QCI value of 1.

After the RLF is declared, the RLF report is logged and included in the VarRLF-Report and, once the UE selects a cell and succeeds with a reestablishment, the UE includes an indication that it has an RLF report available in the RRC Reestablishment Complete message, to make the target cell aware of that availability. Then, upon receiving an UEInformationRequest message with a flag “rlf-ReportReq-r9,” the UE includes the RLF report (stored in a UE variable VarRLF-Report, as described above) in an UEInformationResponse message and sends it to the network.

Based on the RLF report from the UE and the knowledge about with which cell the UE reestablished itself, the original source cell can deduce whether the RLF was caused due to a coverage hole or due to handover-associated parameter configurations. If the RLF was deemed to be due to handover-associated parameter configurations, the original serving cell can further classify the handover-related failure into one of several handover failure classes, i.e., as too early, too late, or a handover to wrong cell. These handover failure classes are explained in brief below.
1) Whether the handover failure occurred due to the ‘too-late handover’ cases
   a. The original serving cell can classify a handover failure to be ‘too late handover’ when the original serving cell fails to send the handover command to the UE associated to a handover towards a particular target cell and if the UE reestablishes itself in this target cell post RLF.
   b. An example corrective action from the original serving cell could be to initiate the handover procedure towards this target cell a bit earlier by decreasing the CIO (cell individual offset) towards the target cell that controls when the IE sends the event triggered measurement report that leads to taking the handover decision.
2) Whether the handover failure occurred due to the ‘too-early handover’ cases
   a. The original serving cell can classify a handover failure to be ‘too early handover’ when the original serving cell is successful in sending the handover command to the UE associated to a handover however the UE fails to perform the random access towards this target cell.
   b. An example corrective action from the original serving cell could be to initiate the handover procedure towards this target cell a bit later by increasing the CIO (cell individual offset) towards the target cell that controls when the IE sends the event triggered measurement report that leads to taking the handover decision.
3) Whether the handover failure occurred due to the ‘handover-to-wrong-cell’ cases
   a. The original serving cell can classify a handover failure to be ‘handover-to-wrong-cell’ when the original serving cell intends to perform the handover for this UE towards a particular target cell but the UE declares the RLF and reestablishes itself in a third cell.

A corrective action from the original serving cell could be to initiate the measurement reporting procedure that leads to handover towards the target cell a bit later by decreasing the CIO (cell individual offset) towards the target cell or via initiating the handover towards the cell in which the UE reestablished a bit earlier by increasing the CIO towards the reestablishment cell.

As part of the Release 17 standardization efforts of 3GPP, the SON MRO framework in 3GPP is further enhanced by introducing the successful handover report (SHR). When configured with SHR, the UE is required to log certain information (such as serving/neighboring cell measurements, HO interruption time, HO parameters value, etc.) if certain conditions are fulfilled during an HO, even though the HO is eventually successful. For example, in the case that the value of T304, started at HO execution, overcomes a configured threshold, the UE should store an SHR associated to this handover. Similar to the RLF-Report, the SHR is transmitted to the network upon request. Upon reception of an SHR, the receiving node is able to analyze whether its mobility configuration needs adjustment. Such adjustments may result in changes of mobility configurations, such as changes of RLM configurations or changes of mobility thresholds between the source and the target. In addition, the target NG RAN node in a performed handover may further optimize the dedicated RACH-beam resources based on the beam measurements reported upon successful handovers.

### SUMMARY

In classical terrestrial networks (TNs), mobility issues (e.g., handover failures or radio link failures) are primarily due to UE mobility. In NTN type of networks instead, the channel may vary not only because of UE mobility, but also because the cell coverage may change over time due to moving satellites, especially if the satellite providing the cell is LEO or MEO, or if the NTN is based on High-Altitude Platform (HAPs) deployments utilizing, for example, tethered unmanned aircraft systems (UAS).

The information currently included in the RLF-Report does not allow the network to determine whether a certain failure, i.e., a handover failure (HOF) or a radio link failure (RLF), is due to the UE mobility or to NTN cell mobility. Additionally, the current RLF-Report does not allow the network to determine whether the HOF/RLF occurred while the UE was under NTN coverage or terrestrial network (TN) coverage.

Furthermore, when a RAN node, e.g., a gNB, receives a SON report, and information in a SON report (e.g., a RLF, a SHR or an RA-Report) concerns event(s) that may impact configuration and/or optimization aspects in another RAN node, the receiving RAN node should forward the SON report to that other RAN node. With legacy procedures designed for TNs, forwarding can be based on the CGI (or E-CGI), or, alternatively, the PCI combined with the carrier frequency for the concerned cell. However, with the dynamic nature of cells in NTNs, i.e., cells moving along the surface of the earth or cells being swapped—with changing PCIs—for the same coverage area, this forwarding mechanism is not reliable in NTNs.

The above issues are present also for other type of SON reports, e.g., the successful handover report (SHR) or the RA-Report.

These problems are addressed by several embodiments described in detail herein. These include methods in which the UE includes certain information in the SON reports, such as RLF-Report, or SHR, or a RA-Report, and associated to a certain event, wherein the event can be a failure (in which case the information will be included in the RLF-Report) or a successful event (in which case the information will be included in the SHR or the RA-Report). The information may include for example:
information on whether the event occurred while the UE was under the NTN or TN coverage, and/or
information on whether the event was due to UE mobility or NTN cell mobility.

This disclosure further describes different methods for the network, comprising:
methods to determine whether to retrieve the SON report information, depending on whether the said SON report is associated to an event occurred in TN or NTN, and
methods for a TN (NTN) to exchange the retrieved information with an NTN (TN) if the retrieved information is associated to an event that occurred in NTN (TN).

An example method in a wireless device operating in a wireless communication network comprises the steps of detecting one of one or more pre-determined triggering events and, responsive to the detected triggering event, determining whether the triggering event occurred while the wireless device was operating under non-terrestrial network coverage or under terrestrial network coverage, and/or determining whether the triggering event was due to wireless device mobility or non-terrestrial network cell mobility. The triggering event might be a radio link failure (RLF), for example, or a handover failure or other issue with handover. This example method further comprises the step of saving, for reporting to the wireless communication network, information corresponding to said determining. This information may comprise, for example, one or more of any of the following: an indication of whether the serving cell in which the triggering event occurred is a terrestrial or non-terrestrial cell; an indication of a non-terrestrial network type for the serving cell in which the triggering event occurred; an indication of a connectivity state for the wireless device when the triggering event occurred; an indication of a last previous serving cell of a different network type to which the wireless device, before connecting to the network of the type of the serving cell in which the triggering event occurred; an indication of when the triggering event occurred, with respect to an end of service time in a non-terrestrial cell in which the triggering event occurred; an indication of when the triggering event occurred, with respect to a time interval for a time-based execution of conditional handover; an indication of whether the event occurred within a coverage zone for a non-terrestrial serving cell in which the triggering event occurred; and an indication of a distance from an edge of a non-terrestrial serving cell coverage zone.

An example method in a network nod comprises the step of receiving, from a wireless device, an indication that the wireless device has a report comprising information indicating whether a triggering event at the wireless device occurred while the wireless device was operating in non-terrestrial network coverage. This example method further comprises determining whether to retrieve the report from the wireless device and retrieving (or not retrieving) the report from the wireless device, in response to said determining. Based on the information contained in the report, the network node may exchange all or part of the report with other nodes, of the same NTN or TN type or of a different type.

Variations of the above techniques as well as corresponding apparatuses and systems are described in further detail below. The various techniques, apparatuses, and systems described herein allow the network to evaluate whether a certain event occurred when the UE was under the NTN or TN coverage, and also whether the event was primarily due to UE mobility of NTN cell mobility.

### BRIEF DESCRIPTION OF THE FIGURES

FIG. 1 illustrates an example architecture of a satellite network with bent pipe transponders.

FIG. 2 illustrates ramifications of Self-Configuration/Self-Optimization functionality (from 3GPP TS 36.300 FIGS. 22.1-1).

FIG. 3 is a process flow diagram illustrating an example method in a wireless device.

FIG. 4 is a process flow diagram illustrating an example method in a network node.

FIG. 5 shows an example of a communication system in accordance with some embodiments.

FIG. 6 shows a wireless device in accordance with some embodiments.

FIG. 7 shows a network node in accordance with some embodiments.

FIG. 8 is a block diagram of a host.

FIG. 9 is a block diagram illustrating a virtualization environment in which functions implemented by some embodiments may be virtualized.

FIG. 10 shows a communication diagram of a host communicating via a network node with a wireless device over a partially wireless connection in accordance with some embodiments.

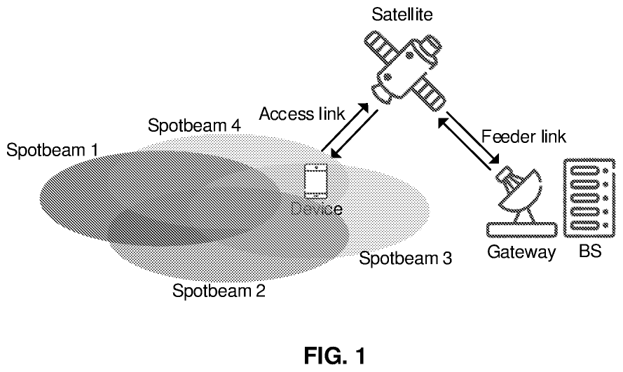

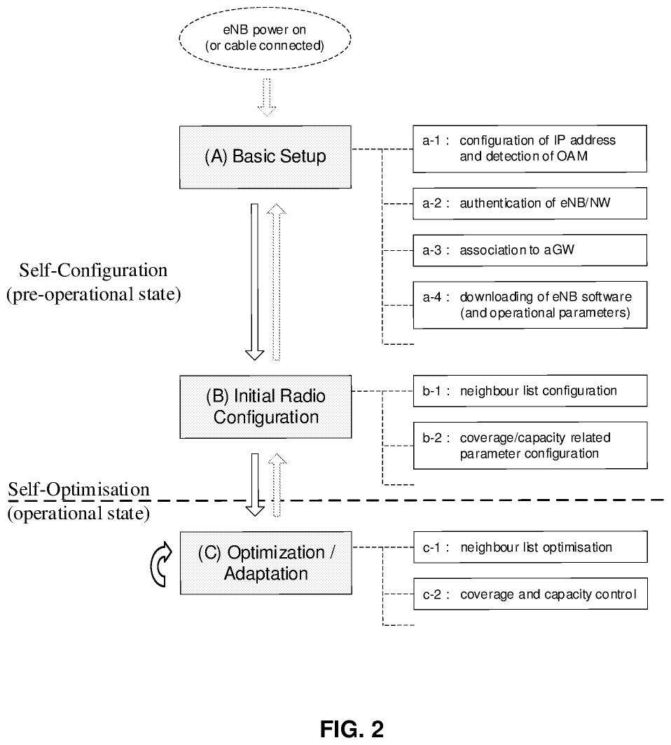

### DETAILED DESCRIPTION

In the description that follows, various techniques and apparatuses are described in the context of LTE and/or NR-based networks. Accordingly, 3GPP terminology pertinent to these networks is used, although the term gNB is frequently used, for convenience, to refer to what should be understood as either being an LTE eNB (base station) or NR gNB, or some combination of both. It will be appreciated, however, that the techniques are more broadly applicable to wireless communications in which a wireless device may operate in either or both of cells provided by non-terrestrial network (NTN) radio access network nodes, such as a satellite-based access node or a high-altitude platform (HAP)-based access node, and terrestrial network (TN) radio access network nodes, such as 3GPP gNBs and eNBs. Similarly, while the 3GPP terms “user equipment” and “UE” are used in the present document, these terms may be understood to refer more generally to wireless access terminals configured to operate in a cellular wireless network. The terms “UE” and “user equipment” should therefore be understood as interchangeable with “wireless device.” The terms “terrestrial network” and “non-terrestrial network” should be understood as each referring to one or more access nodes, where they may be one or several interconnections between one or more of the access nodes or other network nodes in the terrestrial network and one or more access nodes or other network nodes in the non-terrestrial network. To the extent that mobility of a UE between cells provided by access nodes in the terrestrial network and cells provided by access nodes in the non-terrestrial network is supported, the terrestrial and non-terrestrial networks may be regarded as sub-networks of the wireless communication network in which the UE is operating.

### Embodiments Related to UE Actions

Various embodiments of the presently disclosed techniques address the case in which the UE experiences an event, which may be referred to as a “triggering event,” upon which the UE may determine the information associated to such an event and include it in a SON report, such as RLF-Report, SHR, or RA-Report. The triggering event may be an RLF, for example, or the fulfillment of certain conditions for the generation of the SHR (e.g., value of T304, T312, T310 above a certain value when performing the HO, failure in source cell while doing DAPS HO, random access performed in SSBs different than the SSBs configured for CFRA during the HO, etc.), or the execution of a random access procedure, in various embodiments.

The determined information may comprise some or all of the following:
1. An indication of whether the current serving cell in which the event occurred is a TN or NTN cell. In another method the UE may include a specific NTN type, e.g., LEO, GEO, or both LEO and GEO.
2. An indication of whether the previous serving cell to which the UE was connected before connecting to the current serving cell was a TN or an NTN cell, and possibly a specific NTN type (e.g., LEO, GEO, both LEO and GEO). In some embodiments, the UE further indicates whether the UE was in connected state or idle mode or inactive state (e.g., RRC_CONNECTED, RRC_IDLE or RRC_INACTIVE state) when the UE changed from the previous serving cell to the current serving cell. In some embodiments or instances, the UE includes the previous serving cell information only if the UE has been in connected mode while handing over from the previous serving cell to the current serving cell.
3. An indication of the “last serving cell of a different network type” to which the UE was connected before connecting to a cell of the same network type of the current serving cell in which the event occurred. For example, if the UE moved from cell A (TN network type) to cell B (NTN network type) and then to cell C (NTN network type), and then experiences an RLF in cell C, then the UE includes cell A as the last serving cell of a network type (TN) different than the network type in which the failure occurred (NTN). Additionally, the UE may also include the “first serving cell of the same network type” after connecting to this network type, i.e., cell B in this example. As further options, the UE may include indication(s) of the elapsed time since the UE changed from the previous network type to the network type in which the event occurred and/or the number of cells it has traversed since changing to the network type in which the event occurred. This method may be used by the network as per embodiments (205) described below.
4. An indication of whether the event occurred at a point in time before the “end of service time”, or at a point in time after the “end of service time,” wherein the “end of service time” is configured by the serving NTN cell for this NTN cell coverage and provided in SIB signaling or in dedicated configuration (e.g., as part of a CHO configuration).
   In some embodiments, the reason for entering the event could itself be because of going beyond the ‘end of service time’. For example, a UE might declare RLF upon going beyond ‘end of service time’ of a cell. In such a scenario, the UE includes the RLF cause to be ‘end of service time.
   If the event had occurred at a point in time before the ‘end of service time’, then the UE may also store an indicator of the last time instance until which the corresponding NTN serving cell measurements were detectable. In some embodiments, the UE stores the corresponding NTN serving cell measurements periodically until such a serving cell measurement was detectable. Such a periodicity could be a configurable parameter.
5. An indication of the time difference between the point in time in which the event occurred and the “end of service time” indicated by the serving cell, wherein the time difference could be a positive or negative value depending on whether the event occurred before or after the “end of service time”. In another embodiment, the UE includes an “timeToEndOfServiceTime” parameter to represent the time left to the “end of service time” if the event occurred before the “end of service time”, and a “timeSinceEndOfServiceTime” parameter to represent the time elapsed since the “end of service time” if the event occurred after the “end of service time”.
6. In some embodiments, where the UE has been configured with CHO including a time-based execution condition, the determined (101) information may comprise one or more of:
   An indication of whether the event occurred before or after T1.
   An indication of whether the event occurred before or after T2.
   An indication of whether the event occurred within the time interval between T1 and T2.
   An indication of whether the process of detecting the trigger of the event started before or after T1. (The distinction between the start of the process of detecting the trigger of an event and the occurrence of the event can be illustrated by an RLF event, which may be triggered by a series of out-of-sync indications from the PHY layer in the UE. The first of the out-of-sync indications may constitute the “start of the process of detecting the trigger of the RLF event”, while the occurrence of the RLF event is when the RLF event is actually triggered by the series of out-of-sync indications, and these two are obviously separated in time.)
   An indication of whether the process of detecting the trigger of the event started before or after T2.
   An indication of whether the process of detecting the trigger of the event started within the time interval between T1 and T2.
   An indication of whether the event occurred after T2 but before the end of service time.
   An indication of whether the process of detecting the trigger of the event started before T2, while the event occurred after T2.
   An indication of whether the process of detecting the trigger of the event started before T2, while the event occurred between T2 and the end of service time
   An indication of whether the process of detecting the trigger of the event started within the time interval between T1 and T2, while the event occurred after T2.
   An indication of whether the process of detecting the trigger of the event started within the time interval between T1 and T2, while the event occurred between T2 and the end of service time.
   An indication of whether the process of detecting the trigger of the event started before T1, while the event occurred after T1.
   An indication of whether the process of detecting the trigger of the event started before T1, while the event occurred within the time interval between T1 and T2.
   An indication of whether the process of detecting the trigger of the event started before T1, while the event occurred after T2.
   An indication of whether the process of detecting the trigger of the event started before T1, while the event occurred within the time interval between T1 and the end of service time.
   An indication of the time difference between the occurrence of the event and T1, wherein this time difference may be positive or negative (or zero).
   An indication of the time difference between the occurrence of the event and T2, wherein this time difference may be positive or negative (or zero).
   An indication of the time difference between the start of the process of detecting the trigger of the event and T1, wherein this time difference may be positive or negative (or zero).
   An indication of the time difference between the start of the process of detecting the trigger of the event and T2, wherein this time difference may be positive or negative (or zero).
7. An indication of whether the event occurred in a location within a “coverage zone” or outside the “coverage zone” of the NTN serving cell, wherein a “coverage zone” may be one of the coverage zones that the NTN serving cell may cover at a given point in time.
8. An indication of the distance, e.g., expressed in geographical coordinates, to the exit of the “coverage zone” if the event occurred within an NTN coverage zone, or the distance from the last measured location in which the UE was within the “coverage zone” if the event occurred outside the NTN coverage zone.

In all of the above listed options for what may be included in the determined information which in one way or the other includes an indication of, a time indication of, or a reference to, the occurrence of the event, a similar option may be created by replacing the occurrence of the event with the start of the process of detecting the trigger of the event. The distinction between the start of the process of detecting the trigger of an event and the occurrence of the event can be illustrated by an RLF event, which may be triggered by a series of out-of-sync indications from the PHY layer in the UE. The first of the out-of-sync indications may constitute the “start of the process of detecting the trigger of the RLF event”, while the occurrence of the RLF event is when the RLF event is actually triggered by the series of out-of-sync indications, and these two are obviously separated in time.

In a further embodiment, if the UE initiates connection establishment (e.g., RRC connection establishment) in a cell shortly before the cell's end of service time, and the connection establishment is not concluded before the end of service time occurs and the connection establishment thus fails, the UE may include information related to this event in a SON report, e.g., a Connection Establishment Failure Report (ConnEstFailReport) and indicate the cause of the event to be that the end of service time was passed.

The following ASN.1 code could be adopted to capture some of the above information in the case where the event is an RLF:

----------------------- begin proposed ASN.1 code excerpt ------------------------------

| | |
|---|---|
| RLF-Report-r16 ::= | CHOICE { |
| nr-RLF-Report-r16 | SEQUENCE { |
| measResultLastServCell-r16 | MeasResultRLFNR-r16, |
| measResultNeighCells-r16 | SEQUENCE { |
| measResultListNR-r16 | MeasResultList2NR-r16 |
| OPTIONAL, | |
| measResultListEUTRA-r16 | MeasResultList2EUTRA-r16 |
| OPTIONAL | |
| } | OPTIONAL, |
| c-RNTI-r16 | RNTI-Value, |
| previousPCellId-r16 | CHOICE { |
| nrPreviousCell-r16 | CGI-Info-Logging-r16, |
| eutraPreviousCell-r16 | CGI-InfoEUTRALogging |
| } | |
| OPTIONAL, | |
| failedPCellId-r16 | CHOICE { |
| nrFailedPCellId-r16 | CHOICE { |
| cellGlobalId-r16 | CGI-Info-Logging-r16, |
| pci-arfcn-r16 | SEQUENCE { |
| physCellId-r16 | PhysCellId, |
| carrierFreq-r16 | ARFCN-ValueNR |
| } | |
| }, | |
| eutraFailedPCellId-r16 | CHOICE { |
| cellGlobalId-r16 | CGI-InfoEUTRALogging, |
| pci-arfcn-r16 | SEQUENCE { |
| physCellId-r16 | EUTRA-PhysCellId, |
| carrierFreq-r16 | ARFCN-ValueEUTRA |
| } | |
| } | |
| }, | |
| reconnectCellId-r16 | CHOICE { |
| nrReconnectCellId-r16 | CGI-Info-Logging-r16, |
| eutraReconnectCellId-r16 | CGI-InfoEUTRALogging |
| } | |
| OPTIONAL, | |
| timeUntilReconnection-r16 | TimeUntilReconnection-r16 |
| OPTIONAL, | |
| reestablishmentCellId-r16 | CGI-Info-Logging-r16 |
| OPTIONAL, | |
| timeConnFailure-r16 | INTEGER (0..1023) |
| OPTIONAL, | |
| timeSinceFailure-r16 | TimeSinceFailure-r16, |
| connectionFailureType-r16 | ENUMERATED {rlf, hof}, |
| rlf-Cause-r16 | ENUMERATED {t310-Expiry, |
| randomAccessProblem, rlc-MaxNumRetx, | |

beamFailureRecoveryFailure, lbtFailure-r16,

| | |
|---|---|
| | bh- |
| rlfRecoveryFailure, spare2, spare1}, | |
| locationInfo-r16 | LocationInfo-r16 |
| OPTIONAL, | |
| noSuitableCellFound-r16 | ENUMERATED {true} |
| OPTIONAL, | |
| ra-InformationCommon-r16 | RA-InformationCommon-r16 |
| OPTIONAL, | |
| ..., | |
| [[ | |
| csi-rsRLMConfigBitmap-v1650 | BIT STRING (SIZE (96)) |
| OPTIONAL | |
| ]], | |
| [[ | |
| servingCellNetworkType | ENUMERATED {TN, NTN}, |
| beforeEndOfServiceTime | BOOLEAN, |
| timeSinceEndOfServiceTime | INTEGER (0..1023), |
| timeToEndOfServiceTime | INTEGER (0..1023), |
| lastTNServingCell | CHOICE { |
| nrPreviousCell-r16 | CGI-Info-Logging-r16, |
| eutraPreviousCell-r16 | CGI-InfoEUTRALogging |
| }, | |
| firstNTNServingCell | CHOICE { |
| nrPreviousCell-r16 | CGI-Info-Logging-r16, |
| eutraPreviousCell-r16 | CGI-InfoEUTRALogging |
| } | |
| ]] | |
| }, | |
| eutra-RLF-Report-r16 | SEQUENCE { |
| failedPCellId-EUTRA | CGI-InfoEUTRALogging, |
| measResult-RLF-Report-EUTRA-r16 | OCTET STRING, |
| ... | |
| } | |
| } | |

------------------------ end proposed ASN.1 code excerpt -------------------------------

Upon determining the above information, the UE may include and store this information in a SON report, e.g., as per any of the following:
1. In one method (method 1) a different SON report is allocated for different events occurred in different network types. For example, if the UE experiences an RLF in an NTN network, the associated NTN RLF-Report is included in an NTN dedicated RLF-Report, whereas if the failure occurs in a TN network, the RLF information are stored in the legacy RLF-Report.
2. In another method (method 2), a different entry of a SON report is allocated for different events occurred in different network types. For example, if the UE experiences an RLF in an NTN network, the associated NTN RLF-Report is included in an RLF-Report as a dedicated entry, separate from the entry in which the UE stores the RLF-information associated to an RLF occurred in a TN network.
3. In another method (method 3), the same entry and the same SON report is allocated for different events occurred in different network types. For example, if the UE experiences an RLF in an NTN network, the associated NTN RLF-Report is included in an RLF-Report overriding any previous information stored therein, irrespective of whether the previous stored information is associated to a TN or NTN failure.

The same methods as above may be applicable in case the UE generates an SHR or RA-Report.

For example, for the case of method 1 and in case the event is an RLF, a different UE variable is introduced in the ASN.1 to store the NTN-related RLF-report, e.g., denoted as “VarRLF-NTN-Report, whereas the legacy UE variable VarRLF-Report is used just to store the TN-related RLF-Report:

----------------------- begin proposed ASN.1 code excerpt ------------------------------

| | |
|---|---|
| VarRLF-NTN-Report-r16 ::= | SEQUENCE { |
| rlf-Report-r16 | RLF-Report-r16, |
| plmn-IdentityList-r16 | PLMN-IdentityList2-r16 |
| } | |

------------------------ end proposed ASN.1 code excerpt -------------------------------

Upon including the determined information in a SON report as per the above methods, the UE may transmit to the network the “availability information” associated to the event. This availability information may comprise a flag indicating to the network that the UE has stored information associated to a certain NTN event, or TN event or both NTN and TN. For example, if the method 2 or 3 discussed above are adopted, the UE may include availability of both NTN and TN event information if the UE has stored information for both at least one NTN RLF-Report and TN RLF-Report. If method 3 is adopted, either the TN or NTN availability information flag can be included. The transmission of availability indication may be included in certain RRC messages, such as RRCReconfigurationComplete, RRCReestablishmentComplete, RRCResumeComplete, RRCSetupComplete, and may be performed according to any of the below methods:
In some embodiments or instances, the transmission of such availability indication occurs irrespective of the network type in which the RRC message containing the availability indication is transmitted. For example, if the UE has available information associated to an event occurred in the TN, the associated availability information may be transmitted either in messages transmitted to the TN or NTN. For example, the UE may transmit “availability information” flag in one of the above mentioned RRC messages irrespective of whether that is transmitted to a TN or an NTN.
In other embodiments or instances, the transmission of such availability indication is performed only in the network type for which the UE has available information. For example, if the UE has available information associated to an event occurred in the TN, the associated availability information may be transmitted only in messages transmitted to the TN. Similarly, if the UE has available information associated with an event that occurred in the NTN, the UE may include the corresponding availability information only in messages transmitted in the NTN. Furthermore, if the UE has available information associated with both the TN and the NTN, the UE may include the corresponding availability information in messages transmitted in either or both of the TN and/or the NTN. The latter may be more relevant the more the logged information pertaining to the TN and information pertaining to the NTN are integrated with each other, e.g., as in method 3.

Upon indicating the availability information, and upon being requested by the network, the UE transmits the stored SON report in a RRC information response message, e.g., UEInformationResponse.

As an example, the ASN.1 code for the availability information may look like the following wherein the legacy availability information is supposed to be included in case the stored event is associated to an event occurred in the TN:

----------------------- begin proposed ASN.1 code excerpt ------------------------------

| | |
|---|---|
| UE-MeasurementsAvailable-r16 ::= | SEQUENCE { |
| logMeasAvailable-r16 | ENUMERATED {true} |
| OPTIONAL, | |
| logMeasAvailableBT-r16 | ENUMERATED {true} |
| OPTIONAL, | |
| logMeasAvailableWLAN-r16 | ENUMERATED {true} |
| OPTIONAL, | |
| connEstFailInfoAvailable-r16 | ENUMERATED {true} |
| OPTIONAL, | |
| rlf-InfoAvailable-r16 | ENUMERATED {true} |
| OPTIONAL, | |
| NTNconnEstFailInfoAvailable-r17 | ENUMERATED {true} |
| OPTIONAL, | |
| NTNrlf-InfoAvailable-r17 | ENUMERATED {true} |
| OPTIONAL, | |
| ... | |
| } | |

------------------------ end proposed ASN.1 code excerpt -------------------------------

### Embodiments Related to Network Node Actions

Upon receiving the UE availability information from the UE (as per the actions described for the UE, above), a network node may determine whether to request the UE to transmit the available SON report or not.

Such determining may be based on any of the following methods:
1. Whether the network node is of a network type which is the same network type under which the UE experienced the event for which the UE has reported in the availability information of a SON report. For example, if the UE indicates availability of an NTN RLF-Report and the network node is an NTN network node, then the network node may request the UE to transmit the NTN RLF-Report. Otherwise, if the availability information is for a TN RLF-Report the network node may not issue the transmission request to the UE.
2. Whether the network node has a communication interface (e.g., Xn interface) to the network type for which the UE has indicated the availability information, i.e., the network type under which the UE experienced the event for which the UE has reported in the availability information of a SON report. For example, if the UE indicates availability of an NTN RLF-Report and the network node is an TN network node, and this network node has an Xn interface with an NTN network node, then this network node may request the UE to transmit the said NTN RLF-Report. Otherwise, if the TN network node does not have a communication interface with an NTN network node, this network node does not request the NTN RLF-Report.
3. Whether the network node is configured by the OAM to request a SON report irrespective of whether that is associated to an event occurred in the same network type or a different one.

If the outcome of the determining action is that the network should request the SON report, the network node transmits a request, e.g., a UEInformationRequest message, requesting the transmission of a specific SON report of a specific network type, or of different SON reports of different network types.

As an example, the ASN.1 code for the UEInformationRequest message may be as follows, wherein the legacy report request (e.g., ra-ReportReq, rlf-ReportReq) is considered to be applicable only to request TN SON reports:

----------------------- begin proposed ASN.1 code excerpt ------------------------------

| | |
|---|---|
| UEInformationRequest-r16-IEs ::= | SEQUENCE { |
| idleModeMeasurementReq-r16 | ENUMERATED {true} |
| OPTIONAL, -- Need N | |
| logMeasReportReq-r16 | ENUMERATED {true} |
| OPTIONAL, -- Need N | |
| connEstFailReportReq-r16 | ENUMERATED {true} |
| OPTIONAL, -- Need N | |
| ra-ReportReq-r16 | ENUMERATED {true} |
| OPTIONAL, -- Need N | |
| rlf-ReportReq-r16 | ENUMERATED {true} |
| OPTIONAL, -- Need N | |
| mobilityHistoryReportReq-r16 | ENUMERATED {true} |
| OPTIONAL, -- Need N | |
| lateNonCriticalExtension | OCTET STRING |
| OPTIONAL, | |
| nonCriticalExtension | UEInformationRequest-r17-IEs |
| OPTIONAL | |
| } | |
| UEInformationRequest-r17-IEs ::= | SEQUENCE { |
| NTNconnEstFailReportReq-r17 | ENUMERATED {true} |
| OPTIONAL, -- Need N | |
| NTNra-ReportReq-r17 | ENUMERATED {true} |
| OPTIONAL, -- Need N | |
| NTNrlf-ReportReq-r17 | ENUMERATED {true} |
| OPTIONAL, -- Need N | |
| } | |

------------------------ end proposed ASN.1 code excerpt -------------------------------

Transmitting the request will be followed by the reception of the SON report.

Upon receiving the SON report, the cell receiving it may perform any of the following actions:
1. Transmitting the SON report to the RAN node, e.g., gNB, controlling the cell in which the event was generated, e.g., the “failed cell” and/or the “previous cell before the failure occurred” indicated in the SON report if there is network interface.
2. Discarding the SON report if the cell in which the SON report was received is of a network type different than the network type of the cell in which the failure occurred, or if the RAN node (e.g., gNB) controlling said cell in which the SON report was received does not have a communication interface with the RAN node controlling the cell in which the failure occurred.
3. Transmitting the SON report to the RAN node, e.g., gNB, controlling the “last serving cell” of the same network type as the cell in which the SON report was received. For example, if the cell in which the SON report was received is a TN cell, then the RAN node controlling this cell forwards the SON report to the RAN node controlling the last TN serving cell before the failure occurred. This is because the UE may have been handed over from last TN serving cell to an NTN cell, and hence the RAN node controlling the last TN serving cell may have a communication interface (e.g., for control signaling) with the NTN network. Hence, in turn, upon receiving the forwarded SON report, the RAN node controlling the last TN serving cell may in turn forward the SON report to a RAN node controlling an NTN serving cell, e.g., the failed NTN cell of the first NTN serving cell as per the method 3 described above for the UE.

Upon receiving the SON report, the NTN network may further evaluate the SON report, and it may perform the following steps:
1. If a failure event occurred before the “end of service time” or within the “coverage zone”, then the network may conclude that the failure may be due to UE mobility and classify it accordingly. For example, based on other (legacy) information included in the RLF-Report, the network may classify this failure e.g., as too-early HO, or too late-HO, or HO to wrong cell.
2. If a failure event occurred after the “end of service time” or outside the “coverage zone,” then the network may conclude that the failure is due to NTN cell mobility and classify it accordingly. For example, the network may adjust the configured HO parameters such that other UEs will execute the HO before the “end of service time.”
3. Evaluate the time difference between the event and the “end of service time.” For example, if the “timeToEndOfServiceTime” is small, the network may conclude that cell mobility may have had an impact on the failure event. Accordingly, the network may, for example, anticipate the “end of service time” included in the CHO configuration, such that a UE can execute the HO before the currently configured end of service time. In another example, the network may evaluate the “timeSinceEndOfServiceTime” if the failure occurred after the end of service time. If it is determined that this time is large, then the network may indicate a new postponed “end of service time” that is greater than the current “end of service time” but smaller than the time in which the failure event occurred. This is because if the failure occurred significantly after the end of service time, it may be that the network coverage can be expanded in time compared with the current expected network coverage.
4. The same method as method 3 in which the distance from the exit of the coverage zone is evaluated, either in case of the event occurred within the coverage zone or outside.

In some embodiments, where the network has received one or more SON report(s) including information of the time of the occurrence of the event or the time of the start of the process of detecting the event, and the relation of either or both of these times to T1 and/or T2 of a CHO configuration (and/or in relation to the end of service time of source cell of the CHO configuration), the network may use this information to tune future configurations of T1 and T2 in future CHO configurations (e.g. in terms of the length of the duration of the time interval between T1 and T2, and/or the time difference between T2 and the end of service time of the source cell).

### Further Embodiments Related to Forwarding of SON Reports from a RAN Node to Another RAN Node in NTN

When a RAN node, e.g., a gNB, receives a SON report, and information in a SON report (e.g., a RLF, a SHR or an RA-Report or a NTN specific version of any of these reports) concerns event(s) that may impact configuration/optimization aspects in another RAN node, the receiving RAN node should forward the SON report (or the part of the content of the SON report that pertains to the other RAN node) to that other RAN node. With legacy procedures designed for TNs, such forwarding can be based on the CGI (or E-CGI), or, alternatively, the PCI combined with the carrier frequency for the concerned cell. However, as indicated above, due to the dynamic nature of cells in NTNs (i.e., cells moving along the surface of the earth or cells being swapped—with changing PCIs—for the same coverage area), this forwarding mechanism is not reliable in NTNs.

CGIs may not even be broadcast in the system information (SI) in NTN cells, since CGIs will be mapped to geographical areas comparable in size to a typical TN cell and may be used only for NGAP signaling between the RAN (e.g., the gNB) and the CN (e.g., the AMF). This may rule out CGI inclusion in the SON reports and thus also as a means for forwarding of SON reports between RAN nodes.

One way to make the combination of PCI and carrier frequency useful for SON report forwarding is to associate a timestamp with the event that triggered the SON report. Based on this timestamp, the network can figure out the cell that had the PCI at the time of the concerned event and which RAN node (e.g., gNB) that controlled the cell at that time, and, if the cell is a moving cell, which is now controlled by another RAN node (e.g., gNB), the network can also know which gNB controls the cell at the time of reception of the SON report. In summary, with a timestamp associated with the event that triggered the SON report, the network may, when receiving the SON report, identify the RAN node (e.g., gNB) that controlled the concerned cell associated with the event at the time of the event, as well as—if applicable—the gNB that controls the same cell at the time of the reception of the SON report.

As one option, the RAN node (e.g., gNB) receiving the SON report may forward the SON report to the RAN node (e.g., gNB) that controlled the concerned cell associated with the event at the time of the event.

As another option, the RAN node (e.g., gNB) receiving the SON report may forward the SON report to the RAN node (e.g., gNB) that controls the concerned cell (i.e., the cell associated with the event that triggered SON report) at the time of the reception of the SON report.

As yet another option, the RAN node (e.g., gNB) receiving the SON report may forward the SON report both to the RAN node (e.g., gNB) that controlled the concerned cell associated with the event at the time of the event and to the RAN node (e.g., gNB) that controls the concerned cell (i.e. the cell associated with the event that triggered SON report) at the time of the reception of the SON report.

The event timestamp is thus an enabling means for these embodiments. In the RLF-Report and the ConnEstFailReport there is already a timestamp, denoted as timeSinceFailure, which may serve this purpose. A similar timestamp may also be introduced in the yet to be finally specified SHR. As for the RA-Report, a timestamp could be added indicating the start of the RA procedure, or even a timestamp for each RA attempt. A timestamp indicating the start of the RA procedure could advantageously be included in the RA-InformationCommon information element (IE).

There are several options for how a RAN node (e.g., a gNB) may figure out which RAN node (e.g., gNB) was serving a cell with a certain PCI (on a certain carrier frequency) at a certain point in time, including the time of an event that triggered a received SON report and the point in time of the reception of a SON report:
The RAN node (e.g., gNB) may use configured information about schedules for cells associations with PCIs and associations with gNBs.
The RAN node (e.g., gNB) may use a lookup database or lookup service in another network node.
The RAN node (e.g., gNB) may retrieve the relevant information from an entity in the O&M system.
If the RAN node (e.g., gNB) has a neighbor relation with a concerned RAN node (e.g., gNB), either via an inter-RAN node (e.g., an Xn interface) or via NG interfaces, it could utilize information obtained from the concerned RAN node (e.g., gNB) through the neighbor relation, e.g., when the neighbor relation (e.g., the Xn interface) was established.

As a further option, the forwarding of a SON report (or parts of the content of a SON report) from one RAN node (e.g., gNB) to another may be done via an entity in the O&M system. This may be beneficial when inter-RAN node interfaces supporting the forwarding are absent.

The embodiments above may apply when the cell associated with the event that triggered a SON report is an NTN cell (and the RAN node (e.g., gNB) to which the SON report (or part of the content of the SON report) is to be forwarded to hence is an NTN RAN node (e.g., a NTN gNB). The RAN node (e.g., gNB) forwarding the SON report (or part of the content of the SON report) may be either an NTN RAN node (e.g., gNB) or a TN RAN node (e.g., gNB).

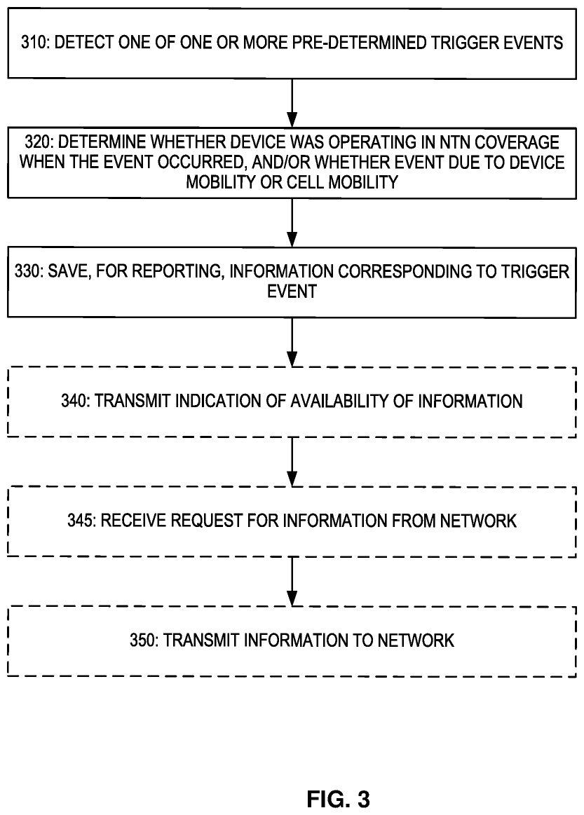

In view of the techniques described above, it will be appreciated that FIG. 3 is a process flow diagram illustrating an example method as carried out by a wireless device operating in a wireless communication network. This illustrated method is intended to be a generalization of several or all of the UE-related methods described above, and thus should be understood as encompassing similar steps and techniques described above, even where slightly different terminology may be used.

The method shown in FIG. 3 includes the step of detecting one of one or more pre-determined triggering events, as shown at block 310. As shown at block 320, the wireless device, responsive to the detected triggering event, determines whether the triggering event occurred while the wireless device was operating under non-terrestrial network coverage or under terrestrial network coverage, and/or it determines whether the triggering event was due to wireless device mobility or non-terrestrial network cell mobility. As shown at block 330, the wireless device saves, for reporting to the wireless communication network, information corresponding to said determining. Note that “operating under non-terrestrial coverage” means operating in or in association with a cell provided by an access node in a non-terrestrial network, i.e., a non-terrestrial network radio access node, while “operating under terrestrial coverage” means operating in or in association with a cell provided by an access node in a terrestrial network, i.e., a terrestrial network radio access node.

In some embodiments or instances, the method further comprises the step of sending, to the wireless communication network, an indication of the availability of the information. This is shown at block 340 and may comprise, in some embodiments or instances, sending an indication of whether the information is associated to an event occurring under non-terrestrial network coverage.

As shown at block 350, the method may further comprise transmitting the information to the wireless communication network. This may be in response to a request from the wireless communication network—the receiving of such a request is shown at block 345 in FIG. 3.

Transmitting the information may comprise transmitting the information as all or part of a self-organizing network report, e.g., a radio link failure (RLF) report or a successful handover report (SHR) or a random access (RA) report. In various embodiments or instances, the detected triggering event may be a radio link failure (RLF) or a handover failure (HOF), for example.

The information that is saved for reporting may comprise one or more of any one or more of the following, in various embodiments or instances: an indication of whether the serving cell in which the triggering event occurred is a terrestrial or non-terrestrial cell; an indication of a non-terrestrial network type for the serving cell in which the triggering event occurred; an indication of a connectivity state for the wireless device when the triggering event occurred; an indication of a last previous serving cell of a different network type to which the wireless device, before connecting to the network of the type of the serving cell in which the triggering event occurred; an indication of when the triggering event occurred, with respect to an end of service time in a non-terrestrial cell in which the triggering event occurred; an indication of when the triggering event occurred, with respect to a time interval for a time-based execution of conditional handover; an indication of whether the event occurred within a coverage zone for a non-terrestrial serving cell in which the triggering event occurred; an indication of a distance from an edge of a non-terrestrial serving cell coverage zone.

In some embodiments or instances, the method may comprise selecting a report type for storing the information according to a trigger type for the trigger event, such that different reports are stored for respective different trigger types. Likewise, in some embodiments or instances the method may comprise selecting a report type for storing the information according to a type of cell, non-terrestrial cell or terrestrial cell, in which the wireless device was operating when the triggering event occurred, such that different reports are stored for non-terrestrial cells and terrestrial cells.

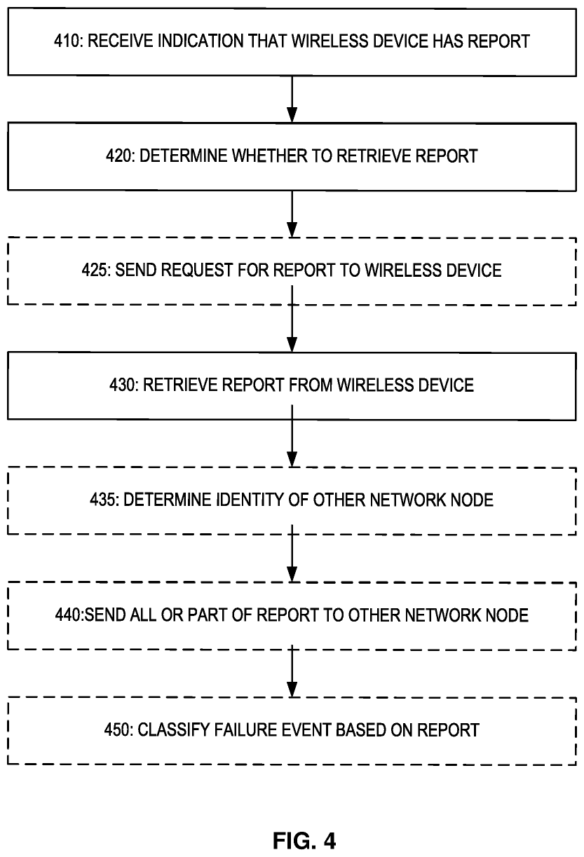

FIG. 4 is a process flow diagram illustrating an example method as carried out by a network node operating in a wireless communication network. This network node may be, for example, a radio access node in either a non-terrestrial or terrestrial network. This illustrated method is intended to be a generalization of several or all of the network node-related methods described above, and thus should be understood as encompassing similar steps and techniques described above, even where slightly different terminology may be used.

As shown at block 410, the illustrated method comprises receiving, from a wireless device, an indication that the wireless device has a report comprising information indicating whether a triggering event at the wireless device occurred while the wireless device was operating in non-terrestrial network coverage. The method further comprises determining whether to retrieve the report from the wireless device, as shown at block 420. The method still further comprises retrieving the report from the wireless device, in response to said determining, as shown at block 430. For clarity, the process flow diagram in FIG. 4 shows the operations when the network node determines to retrieve the report. In some instances, the node may instead elect not to retrieve the report, as discussed in the several examples described above.

In some embodiments or instances, determining whether to retrieve the report is based on whether the network node is a non-terrestrial or terrestrial network node. In some embodiments or instances, the determining may be based on whether the network node has a communication interface with a network of the other type (i.e., terrestrial or non-terrestrial) from the type (terrestrial or non-terrestrial) of the network node.

In some embodiments, the method may comprise sending, to the wireless device, a request for the report. This is shown at block 425 in FIG. 4.

In some embodiments or instances, the method may comprise transmitting all or part of the report to another network node. This is shown at block 440. In some of these embodiments or instances, the method may comprise determining an identity of the other network node, e.g., based on timestamp information in the report. This is shown at block 435 in FIG. 4.

In some embodiments or instances, the other network node to which the report is sent is a network node controlling the cell in which the triggering event occurred, or a network node controlling the cell in which the wireless device was operating prior to the triggering event occurring. In some embodiments or instances, the report indicates that the wireless device was operating in a cell of a first type (terrestrial or non-terrestrial) when the triggering event occurred, and the other network node is identified in the report as the last network node operating a cell of the second type (terrestrial or non-terrestrial) in which the wireless device was operating prior to the triggering event occurring.

In some embodiments or instances, the method further comprises classifying a failure event for the wireless device based on the information in the report. This is shown at block 450 in FIG. 4.

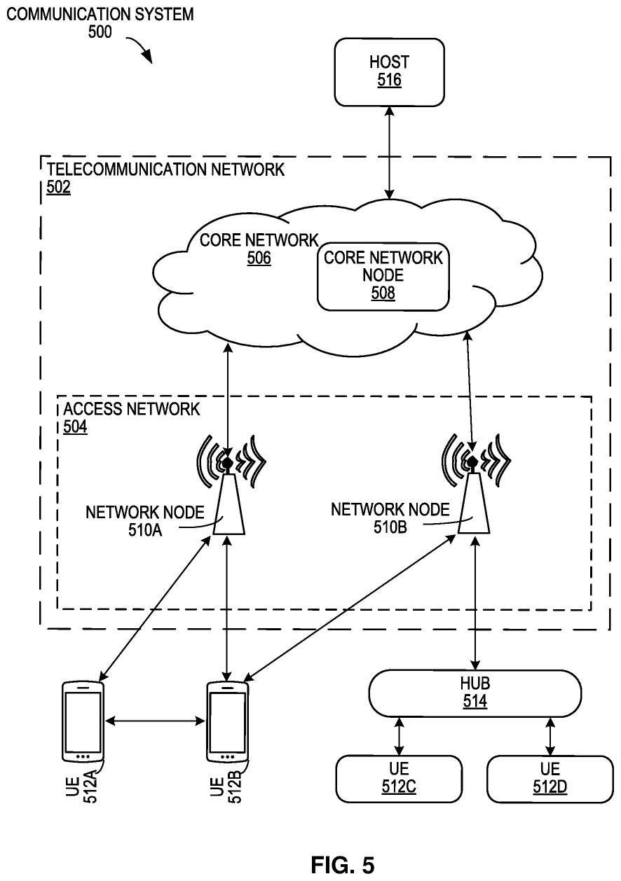

FIG. 5 shows an example of a communication system 500. This illustration is generalized, to provide context for some of the discussion that follows—in this illustration, no distinction is made between terrestrial and non-terrestrial portions of the network. It will be appreciated that one or many of the access nodes, shown as network nodes 510 in FIG. 5, may be non-terrestrial access nodes, while one or many others may be terrestrial access nodes, in various embodiments. The techniques described above may be implemented in such a communication system, in various embodiments.

In the example, the communication system 500 includes a telecommunication network 502 that includes an access network 504, such as a radio access network (RAN), and a core network 506, which includes one or more core network nodes 508. The access network 504 includes one or more access network nodes, such as network nodes 510a and 510b (one or more of which may be generally referred to as network nodes 510), or any other similar 3rd Generation Partnership Project (3GPP) access node or non-3GPP access point. The network nodes 510 facilitate direct or indirect connection of user equipment (UE), such as by connecting UEs 512a, 512b, 512c, and 512d (one or more of which may be generally referred to as UEs 512) to the core network 506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 500 may include any number of wired or wireless networks, network nodes, UEs, and/or any other components or systems that may facilitate or participate in the communication of data and/or signals whether via wired or wireless connections. The communication system 500 may include and/or interface with any type of communication, telecommunication, data, cellular, radio network, and/or other similar types of systems.

The UEs 512 may be any of a wide variety of communication devices, including wireless devices arranged, configured, and/or operable to communicate wirelessly with the network nodes 510 and other communication devices. Similarly, the network nodes 510 are arranged, capable, configured, and/or operable to communicate directly or indirectly with the UEs 512 and/or with other network nodes or equipment in the telecommunication network 502 to enable and/or provide network access, such as wireless network access, and/or to perform other functions, such as administration in the telecommunication network 502.

In the depicted example, the core network 506 connects the network nodes 510 to one or more hosts, such as host 516. These connections may be direct or indirect via one or more intermediary networks or devices. In other examples, network nodes may be directly coupled to hosts. The core network 506 includes one more core network nodes (e.g., core network node 508) that are structured with hardware and software components. Features of these components may be substantially similar to those described with respect to the UEs, network nodes, and/or hosts, such that the descriptions thereof are generally applicable to the corresponding components of the core network node 508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 516 may be under the ownership or control of a service provider other than an operator or provider of the access network 504 and/or the telecommunication network 502 and may be operated by the service provider or on behalf of the service provider. The host 516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 500 of FIG. 5 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 5G, 5G, 7G standards, or any applicable future generation standard (e.g., 8G); wireless local area network (WLAN) standards, such as the Institute of Electrical and Electronics Engineers (IEEE) 1002.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 502 is a cellular network that implements 3GPP standardized features. Accordingly, the telecommunications network 502 may support network slicing to provide different logical networks to different devices that are connected to the telecommunication network 502. For example, the telecommunications network 502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 512 are configured to transmit and/or receive information without direct human interaction. For instance, a UE may be designed to transmit information to the access network 504 on a predetermined schedule, when triggered by an internal or external event, or in response to requests from the access network 504. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 514 communicates with the access network 504 to facilitate indirect communication between one or more UEs (e.g., UE 512c and/or 512d) and network nodes (e.g., network node 510b). In some examples, the hub 514 may be a controller, router, content source and analytics, or any of the other communication devices described herein regarding UEs. For example, the hub 514 may be a broadband router enabling access to the core network 506 for the UEs. As another example, the hub 514 may be a controller that sends commands or instructions to one or more actuators in the UEs. Commands or instructions may be received from the UEs, network nodes 510, or by executable code, script, process, or other instructions in the hub 514. As another example, the hub 514 may be a data collector that acts as temporary storage for UE data and, in some embodiments, may perform analysis or other processing of the data. As another example, the hub 514 may be a content source. For example, for a UE that is a VR headset, display, loudspeaker or other media delivery device, the hub 514 may retrieve VR assets, video, audio, or other media or data related to sensory information via a network node, which the hub 514 then provides to the UE either directly, after performing local processing, and/or after adding additional local content. In still another example, the hub 514 acts as a proxy server or orchestrator for the UEs, in particular in if one or more of the UEs are low energy IoT devices.

The hub 514 may have a constant/persistent or intermittent connection to the network node 510b. The hub 514 may also allow for a different communication scheme and/or schedule between the hub 514 and UEs (e.g., UE 512c and/or 512d), and between the hub 514 and the core network 506. In other examples, the hub 514 is connected to the core network 506 and/or one or more UEs via a wired connection. Moreover, the hub 514 may be configured to connect to an M2M service provider over the access network 504 and/or to another UE over a direct connection. In some scenarios, UEs may establish a wireless connection with the network nodes 510 while still connected via the hub 514 via a wired or wireless connection. In some embodiments, the hub 514 may be a dedicated hub—that is, a hub whose primary function is to route communications to/from the UEs from/to the network node 510b. In other embodiments, the hub 514 may be a non-dedicated hub—that is, a device which is capable of operating to route communications between the UEs and network node 510b, but which is additionally capable of operating as a communication start and/or end point for certain data channels.

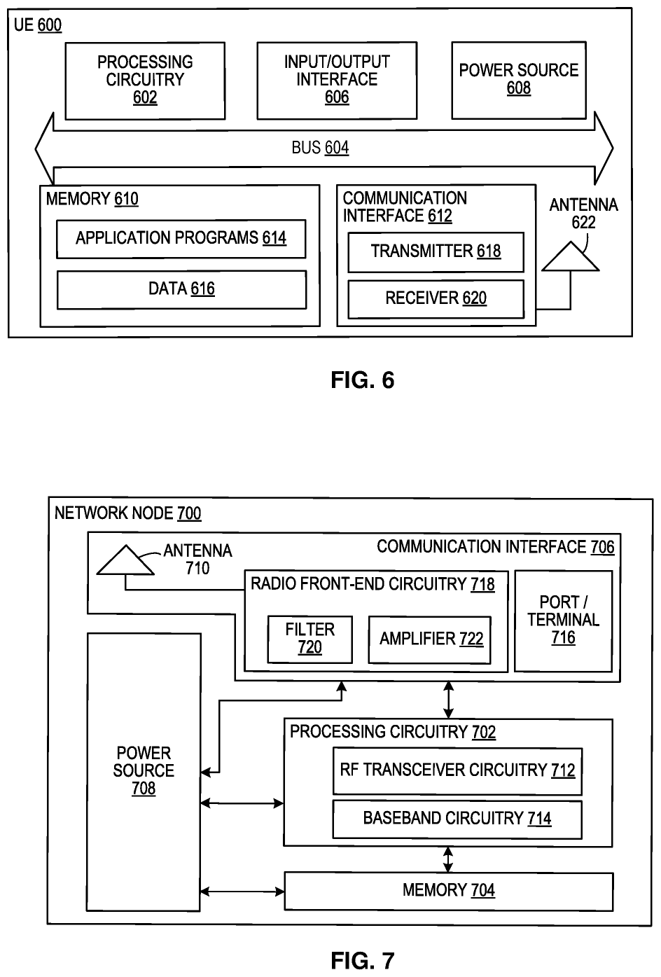

FIG. 6 shows a UE 600 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of an owner or user (e.g., a smart power meter).

The UE 600 includes processing circuitry 602 that is operatively coupled via a bus 604 to an input/output interface 606, a power source 608, a memory 610, a communication interface 612, and/or any other component, or any combination thereof. Certain UEs may utilize all or a subset of the components shown in FIG. 6. The level of integration between the components may vary from one UE to another UE. Further, certain UEs may contain multiple instances of a component, such as multiple processors, memories, transceivers, transmitters, receivers, etc.

The processing circuitry 602 is configured to process instructions and data and may be configured to implement any sequential state machine operative to execute instructions stored as machine-readable computer programs in the memory 610. The processing circuitry 602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 602 may include multiple central processing units (CPUs).

In the example, the input/output interface 606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 608 is structured as a battery or battery pack. Other types of power sources, such as an external power source (e.g., an electricity outlet), photovoltaic device, or power cell, may be used. The power source 608 may further include power circuitry for delivering power from the power source 608 itself, and/or an external power source, to the various parts of the UE 600 via input circuitry or an interface such as an electrical power cable. Delivering power may be, for example, for charging of the power source 608. Power circuitry may perform any formatting, converting, or other modification to the power from the power source 608 to make the power suitable for the respective components of the UE 600 to which power is supplied.

The memory 610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 610 includes one or more application programs 614, such as an operating system, web browser application, a widget, gadget engine, or other application, and corresponding data 616. The memory 610 may store, for use by the UE 600, any of a variety of various operating systems or combinations of operating systems.

The memory 610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 610 may allow the UE 600 to access instructions, application programs and the like, stored on transitory or non-transitory memory media, to off-load data, or to upload data. An article of manufacture, such as one utilizing a communication system may be tangibly embodied as or in the memory 610, which may be or comprise a device-readable storage medium.

The processing circuitry 602 may be configured to communicate with an access network or other network using the communication interface 612. The communication interface 612 may comprise one or more communication subsystems and may include or be communicatively coupled to an antenna 622. The communication interface 612 may include one or more transceivers used to communicate, such as by communicating with one or more remote transceivers of another device capable of wireless communication (e.g., another UE or a network node in an access network). Each transceiver may include a transmitter 618 and/or a receiver 620 appropriate to provide network communications (e.g., optical, electrical, frequency allocations, and so forth). Moreover, the transmitter 618 and receiver 620 may be coupled to one or more antennas (e.g., antenna 622) and may share circuit components, software or firmware, or alternatively be implemented separately.

In the illustrated embodiment, communication functions of the communication interface 612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 1002.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 600 shown in FIG. 6.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 7 shows a network node 700 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points, whether terrestrial or non-terrestrial), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 7G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 700 includes a processing circuitry 702, a memory 704, a communication interface 706, and a power source 708. The network node 700 may be composed of multiple physically separate components (e.g., a NodeB component and a RNC component, or a BTS component and a BSC component, etc.), which may each have their own respective components. In certain scenarios in which the network node 700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 700 may be configured to support multiple radio access technologies (RATs). In such embodiments, some components may be duplicated (e.g., separate memory 704 for different RATs) and some components may be reused (e.g., a same antenna 710 may be shared by different RATs). The network node 700 may also include multiple sets of the various illustrated components for different wireless technologies integrated into network node 700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 700.

The processing circuitry 702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 700 components, such as the memory 704, to provide network node 700 functionality.

In some embodiments, the processing circuitry 702 includes a system on a chip (SOC). In some embodiments, the processing circuitry 702 includes one or more of radio frequency (RF) transceiver circuitry 712 and baseband processing circuitry 714. In some embodiments, the radio frequency (RF) transceiver circuitry 712 and the baseband processing circuitry 714 may be on separate chips (or sets of chips), boards, or units, such as radio units and digital units. In alternative embodiments, part or all of RF transceiver circuitry 712 and baseband processing circuitry 714 may be on the same chip or set of chips, boards, or units.

The memory 704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 702. The memory 704 may store any suitable instructions, data, or information, including a computer program, software, an application including one or more of logic, rules, code, tables, and/or other instructions capable of being executed by the processing circuitry 702 and utilized by the network node 700. The memory 704 may be used to store any calculations made by the processing circuitry 702 and/or any data received via the communication interface 706. In some embodiments, the processing circuitry 702 and memory 704 is integrated.

The communication interface 706 is used in wired or wireless communication of signaling and/or data between a network node, access network, and/or UE. As illustrated, the communication interface 706 comprises port(s)/terminal(s) 716 to send and receive data, for example to and from a network over a wired connection. The communication interface 706 also includes radio front-end circuitry 718 that may be coupled to, or in certain embodiments a part of, the antenna 710. Radio front-end circuitry 718 comprises filters 720 and amplifiers 722. The radio front-end circuitry 718 may be connected to an antenna 710 and processing circuitry 702. The radio front-end circuitry may be configured to condition signals communicated between antenna 710 and processing circuitry 702. The radio front-end circuitry 718 may receive digital data that is to be sent out to other network nodes or UEs via a wireless connection. The radio front-end circuitry 718 may convert the digital data into a radio signal having the appropriate channel and bandwidth parameters using a combination of filters 720 and/or amplifiers 722. The radio signal may then be transmitted via the antenna 710. Similarly, when receiving data, the antenna 710 may collect radio signals which are then converted into digital data by the radio front-end circuitry 718. The digital data may be passed to the processing circuitry 702. In other embodiments, the communication interface may comprise different components and/or different combinations of components.

In certain alternative embodiments, the network node 700 does not include separate radio front-end circuitry 718, instead, the processing circuitry 702 includes radio front-end circuitry and is connected to the antenna 710. Similarly, in some embodiments, all or some of the RF transceiver circuitry 712 is part of the communication interface 706. In still other embodiments, the communication interface 706 includes one or more ports or terminals 716, the radio front-end circuitry 718, and the RF transceiver circuitry 712, as part of a radio unit (not shown), and the communication interface 706 communicates with the baseband processing circuitry 714, which is part of a digital unit (not shown).

The antenna 710 may include one or more antennas, or antenna arrays, configured to send and/or receive wireless signals. The antenna 710 may be coupled to the radio front-end circuitry 718 and may be any type of antenna capable of transmitting and receiving data and/or signals wirelessly. In certain embodiments, the antenna 710 is separate from the network node 700 and connectable to the network node 700 through an interface or port.

The antenna 710, communication interface 706, and/or the processing circuitry 702 may be configured to perform any receiving operations and/or certain obtaining operations described herein as being performed by the network node. Any information, data and/or signals may be received from a UE, another network node and/or any other network equipment. Similarly, the antenna 710, the communication interface 706, and/or the processing circuitry 702 may be configured to perform any transmitting operations described herein as being performed by the network node. Any information, data and/or signals may be transmitted to a UE, another network node and/or any other network equipment.

The power source 708 provides power to the various components of network node 700 in a form suitable for the respective components (e.g., at a voltage and current level needed for each respective component). The power source 708 may further comprise, or be coupled to, power management circuitry to supply the components of the network node 700 with power for performing the functionality described herein. For example, the network node 700 may be connectable to an external power source (e.g., the power grid, an electricity outlet) via an input circuitry or interface such as an electrical cable, whereby the external power source supplies power to power circuitry of the power source 708. As a further example, the power source 708 may comprise a source of power in the form of a battery or battery pack which is connected to, or integrated in, power circuitry. The battery may provide backup power should the external power source fail.

Embodiments of the network node 700 may include additional components beyond those shown in FIG. 7 for providing certain aspects of the network node's functionality, including any of the functionality described herein and/or any functionality necessary to support the subject matter described herein. For example, the network node 700 may include user interface equipment to allow input of information into the network node 700 and to allow output of information from the network node 700. This may allow a user to perform diagnostic, maintenance, repair, and other administrative functions for the network node 700.

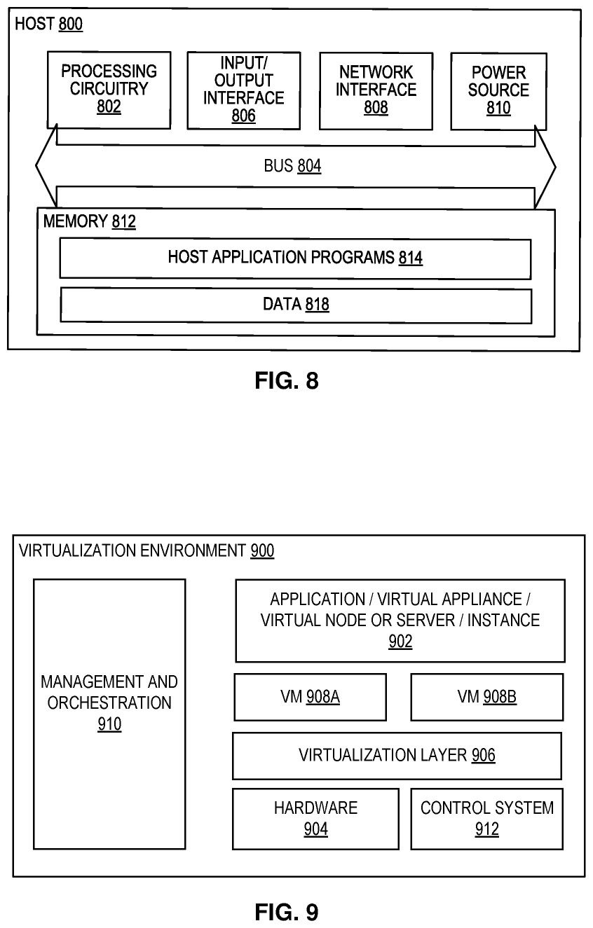

FIG. 8 is a block diagram of a host 800, which may be an embodiment of the host 516 of FIG. 5, in accordance with various aspects described herein. As used herein, the host 800 may be or comprise various combinations hardware and/or software, including a standalone server, a blade server, a cloud-implemented server, a distributed server, a virtual machine, container, or processing resources in a server farm. The host 800 may provide one or more services to one or more UEs.

The host 800 includes processing circuitry 802 that is operatively coupled via a bus 804 to an input/output interface 806, a network interface 808, a power source 810, and a memory 812. Other components may be included in other embodiments. Features of these components may be substantially similar to those described with respect to the devices of previous figures, such as FIGS. 6 and 7, such that the descriptions thereof are generally applicable to the corresponding components of host 800.

The memory 812 may include one or more computer programs including one or more host application programs 814 and data 816, which may include user data, e.g., data generated by a UE for the host 800 or data generated by the host 800 for a UE. Embodiments of the host 800 may utilize only a subset or all of the components shown. The host application programs 814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 814 may also provide for user authentication and licensing checks and may periodically report health, routes, and content availability to a central node, such as a device in or on the edge of a core network. Accordingly, the host 800 may select and/or indicate a different host for over-the-top services for a UE. The host application programs 814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 9 is a block diagram illustrating a virtualization environment 900 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 902 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs)), provide VMs 908a and 908b (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization. Alternatively, hardware 904 may be part of a larger cluster of hardware (e.g., such as in a data center or CPE) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 912 which may alternatively be used for communication between hardware nodes and radio units.

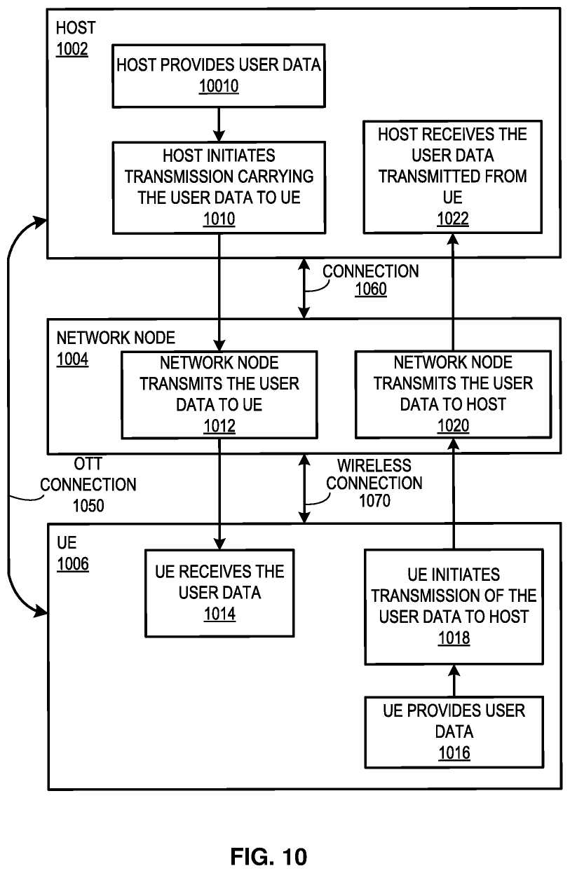

FIG. 10 shows a communication diagram of a host 1002 communicating via a network node 1004 with a UE 1006 over a partially wireless connection in accordance with some embodiments. Example implementations, in accordance with various embodiments, of the UE (such as a UE 512a of FIG. 5 and/or UE 600 of FIG. 6), network node (such as network node 510a of FIG. 5 and/or network node 700 of FIG. 7), and host (such as host 516 of FIG. 5 and/or host 800 of FIG. 8) discussed in the preceding paragraphs will now be described with reference to FIG. 10.

Like host 800, embodiments of host 1002 include hardware, such as a communication interface, processing circuitry, and memory. The host 1002 also includes software, which is stored in or accessible by the host 1002 and executable by the processing circuitry. The software includes a host application that may be operable to provide a service to a remote user, such as the UE 1006 connecting via an over-the-top (OTT) connection 1050 extending between the UE 1006 and host 1002. In providing the service to the remote user, a host application may provide user data which is transmitted using the OTT connection 1050.

The network node 1004 includes hardware enabling it to communicate with the host 1002 and UE 1006. The connection 1060 may be direct or pass through a core network (like core network 506 of FIG. 5) and/or one or more other intermediate networks, such as one or more public, private, or hosted networks. For example, an intermediate network may be a backbone network or the Internet.

The UE 1006 includes hardware and software, which is stored in or accessible by UE 1006 and executable by the UE's processing circuitry. The software includes a client application, such as a web browser or operator-specific “app” that may be operable to provide a service to a human or non-human user via UE 1006 with the support of the host 1002. In the host 1002, an executing host application may communicate with the executing client application via the OTT connection 1050 terminating at the UE 1006 and host 1002. In providing the service to the user, the UE's client application may receive request data from the host's host application and provide user data in response to the request data. The OTT connection 1050 may transfer both the request data and the user data. The UE's client application may interact with the user to generate the user data that it provides to the host application through the OTT connection 1050.

The OTT connection 1050 may extend via a connection 1060 between the host 1002 and the network node 1004 and via a wireless connection 1070 between the network node 1004 and the UE 1006 to provide the connection between the host 1002 and the UE 1006. The connection 1060 and wireless connection 1070, over which the OTT connection 1050 may be provided, have been drawn abstractly to illustrate the communication between the host 1002 and the UE 1006 via the network node 1004, without explicit reference to any intermediary devices and the precise routing of messages via these devices.

As an example of transmitting data via the OTT connection 1050, in step 1008, the host 1002 provides user data, which may be performed by executing a host application. In some embodiments, the user data is associated with a particular human user interacting with the UE 1006. In other embodiments, the user data is associated with a UE 1006 that shares data with the host 1002 without explicit human interaction. In step 1010, the host 1002 initiates a transmission carrying the user data towards the UE 1006. The host 1002 may initiate the transmission responsive to a request transmitted by the UE 1006. The request may be caused by human interaction with the UE 1006 or by operation of the client application executing on the UE 1006. The transmission may pass via the network node 1004, in accordance with the teachings of the embodiments described throughout this disclosure. Accordingly, in step 1012, the network node 1004 transmits to the UE 1006 the user data that was carried in the transmission that the host 1002 initiated, in accordance with the teachings of the embodiments described throughout this disclosure. In step 1014, the UE 1006 receives the user data carried in the transmission, which may be performed by a client application executed on the UE 1006 associated with the host application executed by the host 1002.

In some examples, the UE 1006 executes a client application which provides user data to the host 1002. The user data may be provided in reaction or response to the data received from the host 1002. Accordingly, in step 1016, the UE 1006 may provide user data, which may be performed by executing the client application. In providing the user data, the client application may further consider user input received from the user via an input/output interface of the UE 1006. Regardless of the specific manner in which the user data was provided, the UE 1006 initiates, in step 1018, transmission of the user data towards the host 1002 via the network node 1004. In step 1020, in accordance with the teachings of the embodiments described throughout this disclosure, the network node 1004 receives user data from the UE 1006 and initiates transmission of the received user data towards the host 1002. In step 1022, the host 1002 receives the user data carried in the transmission initiated by the UE 1006.

One or more of the various embodiments improve the performance of OTT services provided to the UE 1006 using the OTT connection 1050, in which the wireless connection 1070 forms the last segment. More precisely, by improving optimization of networks that include terrestrial and non-terrestrial elements, radio link failure, handover failures, and other mobility-related problems can be reduced, thus reducing data interruptions and providing end users with more reliable connection.

In an example scenario, factory status information may be collected and analyzed by the host 1002. As another example, the host 1002 may process audio and video data which may have been retrieved from a UE for use in creating maps. As another example, the host 1002 may collect and analyze real-time data to assist in controlling vehicle congestion (e.g., controlling traffic lights). As another example, the host 1002 may store surveillance video uploaded by a UE. As another example, the host 1002 may store or control access to media content such as video, audio, VR or AR which it can broadcast, multicast or unicast to UEs. As other examples, the host 1002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1050 between the host 1002 and UE 1006, in response to variations in the measurement results. The measurement procedure and/or the network functionality for reconfiguring the OTT connection may be implemented in software and hardware of the host 1002 and/or UE 1006. In some embodiments, sensors (not shown) may be deployed in or in association with other devices through which the OTT connection 1050 passes; the sensors may participate in the measurement procedure by supplying values of the monitored quantities exemplified above, or supplying values of other physical quantities from which software may compute or estimate the monitored quantities. The reconfiguring of the OTT connection 1050 may include message format, retransmission settings, preferred routing etc.; the reconfiguring need not directly alter the operation of the network node 1004. Such procedures and functionalities may be known and practiced in the art. In certain embodiments, measurements may involve proprietary UE signaling that facilitates measurements of throughput, propagation times, latency and the like, by the host 1002. The measurements may be implemented in that software causes messages to be transmitted, in particular empty or ‘dummy’ messages, using the OTT connection 1050 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Example Embodiments

Embodiments of the techniques, apparatuses, and systems described herein include, but are not limited to, the following enumerated examples:

### Group A Embodiments

1. A method, in a wireless device operating in a wireless communication network, the method comprising:
   detecting one of one or more pre-determined triggering events;
   responsive to the detected triggering event, determining whether the triggering event occurred while the wireless device was operating under non-terrestrial network coverage or under terrestrial network coverage, and/or determining whether the triggering event was due to wireless device mobility or non-terrestrial network cell mobility; and
   saving, for reporting to the wireless communication network, information corresponding to said determining.
2. The method of example embodiment 1, further comprising sending, to the wireless communication network, an indication of the availability of the information.
3. The method of example embodiment 2, wherein sending the indication of the availability of the information comprises sending an indication of whether the information is associated to an event occurring under non-terrestrial network coverage.
4. The method of any one of example embodiments 1-3, further comprising transmitting the information to the wireless communication network.
5. The method of example embodiment 4, wherein said transmitting is in response to a request from the wireless communication network.
6. The method of example embodiment 4 or 5, wherein said transmitting the information comprises transmitting the information as part of a self-organizing network report, e.g., a radio link failure (RLF) report or a successful handover report (SHR) or a random access (RA) report.
7. The method of any one of example embodiments 1-6, wherein the detected triggering event is a radio link failure (RLF) or a handover failure (HOF).
8. The method of any of example embodiments 1-7, wherein the information comprises one or more of any one or more of the following:
   an indication of whether the serving cell in which the triggering event occurred is a terrestrial or non-terrestrial cell;
   an indication of a non-terrestrial network type for the serving cell in which the triggering event occurred;
   an indication of a connectivity state for the wireless device when the triggering event occurred;
   an indication of a last previous serving cell of a different network type to which the wireless device, before connecting to the network of the type of the serving cell in which the triggering event occurred;
   an indication of when the triggering event occurred, with respect to an end of service time in a non-terrestrial cell in which the triggering event occurred;
   an indication of when the triggering event occurred, with respect to a time interval for a time-based execution of conditional handover;
   an indication of whether the event occurred within a coverage zone for a non-terrestrial serving cell in which the triggering event occurred;
   an indication of a distance from an edge of a non-terrestrial serving cell coverage zone.
9. The method of any one of example embodiments 1-8, wherein the method comprises selecting a report type for storing the information according to a trigger type for the trigger event, such that different reports are stored for respective different trigger types.
10. The method of any one of example embodiments 1-9, wherein the method comprises selecting a report type for storing the information according to a type of cell, non-terrestrial cell or terrestrial cell, in which the wireless device was operating when the triggering event occurred.
11. The method of any one of example embodiments 1-10, further comprising: providing user data; and
   forwarding the user data to a host via the transmission to the network node.

### Group B Embodiments

B1. A method, in a network node, the method comprising:
   receiving, from a wireless device, an indication that the wireless device has a report comprising information indicating whether a triggering event at the wireless device occurred while the wireless device was operating in non-terrestrial network coverage;
   determining whether to retrieve the report from the wireless device; and
   retrieving the report from the wireless device, in response to said determining.
B2. The method of example embodiment B1, wherein said determining is based on whether the network node is a non-terrestrial or terrestrial network node.
B3. The method of example embodiment B1 or B2, wherein the network node is of a non-terrestrial or terrestrial network type, and wherein said determining is based on whether the network node has a communication interface with a network of the other type from the network node.
B4. The method of any one of example embodiments B1-B3, wherein retrieving the report comprises sending, to the wireless device, a request for the report.
B5. The method of any one of example embodiments B1-B4, wherein the method further comprises transmitting all or part of the report to another network node.
B6. The method of example embodiment B5, wherein the method comprises determining an identity of the other network node based on timestamp information in the report.
B7. The method of example embodiment B5 or B6, wherein the other network node is a network node controlling the cell in which the triggering event occurred, or a network node controlling the cell in which the wireless device was operating prior to the triggering event occurring.
B8. The method of example embodiment B5, wherein the report indicates that the wireless device was operating in a cell of a first type (terrestrial or non-terrestrial) when the triggering event occurred, and the other network node is identified in the report as the last network node operating a cell of the second type (terrestrial or non-terrestrial) in which the wireless device was operating prior to the triggering event occurring.
B9. The method of any one of example embodiments B1-B7, wherein the method further comprises classifying a failure event for the wireless device based on the information.
B10. The method of example embodiment B8, wherein said classifying is based on an indication, in the information, of when the triggering event occurred, with respect to an end of service time for the serving cell in which the triggering event occurred, or is based on an indication of whether the wireless device was in a coverage zone for the serving cell in which the triggering event occurred, or both.
B11. The method of any one of example embodiments B1-B10, further comprising: obtaining user data; and
   forwarding the user data to a host or a user equipment.

### Group C Embodiments

C1. A user equipment for reporting events in non-terrestrial network coverage, comprising:
   processing circuitry configured to perform any of the steps of any of the Group A embodiments; and
   power supply circuitry configured to supply power to the processing circuitry.
C2. A network node for retrieving reports of events in non-terrestrial network coverage, the network node comprising:
   processing circuitry configured to perform any of the steps of any of the Group B embodiments;
   power supply circuitry configured to supply power to the processing circuitry.
C3. A user equipment (UE) for reporting events in non-terrestrial network coverage, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
C4. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to receive the user data from the host.
C5. The host of the previous embodiment, wherein the cellular network further includes a network node configured to communicate with the UE to transmit the user data to the UE from the host.
C6. The host of the previous 2 embodiments, wherein:
   the processing circuitry of the host is configured to execute a host application, thereby providing the user data; and
   the host application is configured to interact with a client application executing on the UE, the client application being associated with the host application.
C7. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A embodiments to receive the user data from the host.
C8. The method of the previous embodiment, further comprising:
   at the host, executing a host application associated with a client application executing on the UE to receive the user data from the UE.
C9. The method of the previous embodiment, further comprising:
   at the host, transmitting input data to the client application executing on the UE, the input data being provided by executing the host application,
   wherein the user data is provided by the client application in response to the input data from the host application.
C10. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to transmit the user data to the host.
C11. The host of the previous embodiment, wherein the cellular network further includes a network node configured to communicate with the UE to transmit the user data from the UE to the host.
C12. The host of the previous 2 embodiments, wherein:
   the processing circuitry of the host is configured to execute a host application, thereby providing the user data; and
   the host application is configured to interact with a client application executing on the UE, the client application being associated with the host application.
C13. A method implemented by a host configured to operate in a communication system that further includes a network node and a user equipment (UE), the method comprising:
   at the host, receiving user data transmitted to the host via the network node by the UE, wherein the UE performs any of the steps of any of the Group A embodiments to transmit the user data to the host.
C14. The method of the previous embodiment, further comprising:
   at the host, executing a host application associated with a client application executing on the UE to receive the user data from the UE.
C15. The method of the previous embodiment, further comprising:
   at the host, transmitting input data to the client application executing on the UE, the input data being provided by executing the host application,
   wherein the user data is provided by the client application in response to the input data from the host application.
C16. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
C17. The host of the previous embodiment, wherein:
   the processing circuitry of the host is configured to execute a host application that provides the user data; and
   the UE comprises processing circuitry configured to execute a client application associated with the host application to receive the transmission of user data from the host.
C18. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group B embodiments to transmit the user data from the host to the UE.
C19. The method of the previous embodiment, further comprising, at the network node, transmitting the user data provided by the host for the UE.
C20. The method of any of the previous 2 embodiments, wherein the user data is provided at the host by executing a host application that interacts with a client application executing on the UE, the client application being associated with the host application.
C21. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
C22. The communication system of the previous embodiment, further comprising:
   the network node; and/or
   the user equipment.
C23. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
C24. The host of the previous 2 embodiments, wherein:
   the processing circuitry of the host is configured to execute a host application, thereby providing the user data; and
   the host application is configured to interact with a client application executing on the UE, the client application being associated with the host application.
C25. The host of the any of the previous 2 embodiments, wherein the initiating receipt of the user data comprises requesting the user data.
C26. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
C27. The method of the previous embodiment, further comprising at the network node, transmitting the received user data to the host.

### Abbreviations

| Abbreviation | Explanation |
|---|---|
| GEO | Geostationary Equatorial Orbit |
| LEO | Low Earth Orbit |
| MDT | Minimization of Drive tests |
| NTN | Non-Terrestrial Network |
| RRC | Radio Resource Control |
| S-NSSAI | Single Network Slice Selection Assistance Information |
| SST | Slice Type |
| TN | Terrestrial Network |
| UE | User Equipment |
| RLF | Radio Link Failure |
| SHR | Successful Handover Report |
| HO | Handover |
| RA | Random Access |
| NW | Network |
| RLC | Radio Link Control |
| MAC | Medium Access Control |
| SON | Self-organizing network |
| CFRA | Contention Free Random Access |
| CHO | Conditional Handover |
| PHY | Physical Layer |
| RA | Random Access |
| OAM | Administration and Maintenance |
| RAN | Radio Access Network |
| CGI | Cell Global Identity |
| SI | System Information |
| PCI | Physical cell identity |

### REFERENCES

1. 3GPP TR 38.832 Study on enhancement of Radio Access Network (RAN) slicing, 3GPP
2. 3PP TS37.320 Universal Terrestrial Radio Access (UTRA) and Evolved Universal Terrestrial Radio Access (E-UTRA); Radio measurement collection for Minimization of Drive Tests (MDT); Overall description; Stage 2, 3GPP

1-30. (canceled)

31. A method, in a wireless device operating in a wireless communication network, the method comprising:
detecting one of one or more pre-determined triggering events;
responsive to the detected triggering event, determining whether the triggering event occurred while the wireless device was operating under non-terrestrial network coverage or under terrestrial network coverage, and/or determining whether the triggering event was due to wireless device mobility or non-terrestrial network cell mobility; and
saving, for reporting to the wireless communication network, information corresponding to said determining.

32. The method of claim 31, further comprising sending, to the wireless communication network, an indication of the availability of the information.

33. The method of claim 32, wherein sending the indication of the availability of the information comprises sending an indication of whether the information is associated to an event occurring under non-terrestrial network coverage.

34. The method of claim 31, further comprising transmitting the information to the wireless communication network, wherein said transmitting is in response to a request from the wireless communication network.

35. The method of claim 34, wherein said transmitting the information comprises transmitting the information as part of a self-organizing network report, e.g., a radio link failure (RLF) report or a successful handover report (SHR) or a random access (RA) report.

36. The method of claim 31, wherein the detected triggering event is a radio link failure (RLF) or a handover failure (HOF).

37. The method of claim 31, wherein the information comprises one or more of any one or more of the following:
an indication of whether the serving cell in which the triggering event occurred is a terrestrial or non-terrestrial cell;
an indication of a non-terrestrial network type for the serving cell in which the triggering event occurred;
an indication of a connectivity state for the wireless device when the triggering event occurred;
an indication of a last previous serving cell of a different network type to which the wireless device, before connecting to the network of the type of the serving cell in which the triggering event occurred;
an indication of when the triggering event occurred, with respect to an end of service time in a non-terrestrial cell in which the triggering event occurred;
an indication of when the triggering event occurred, with respect to a time interval for a time-based execution of conditional handover;
an indication of whether the event occurred within a coverage zone for a non-terrestrial serving cell in which the triggering event occurred;
an indication of a distance from an edge of a non-terrestrial serving cell coverage zone.

38. The method of claim 31, wherein the method comprises selecting a report type for storing the information according to a trigger type for the trigger event, such that different reports are stored for respective different trigger types.

39. The method of claim 31, wherein the method comprises selecting a report type for storing the information according to a type of cell, non-terrestrial cell or terrestrial cell, in which the wireless device was operating when the triggering event occurred.

40. A method, in a network node, the method comprising:
receiving, from a wireless device, an indication that the wireless device has a report comprising information indicating whether a triggering event at the wireless device occurred while the wireless device was operating in non-terrestrial network coverage;
determining whether to retrieve the report from the wireless device; and
retrieving the report from the wireless device, in response to said determining.

41. The method of claim 40, wherein said determining is based on whether the network node is a non-terrestrial or terrestrial network node.

42. The method of claim 40, wherein the network node is of a non-terrestrial or terrestrial network type, and wherein said determining is based on whether the network node has a communication interface with a network of the other type from the network node.

43. The method of claim 40, wherein retrieving the report comprises sending, to the wireless device, a request for the report.

44. The method of claim 40, wherein the method further comprises transmitting all or part of the report to another network node, and wherein the method comprises determining an identity of the other network node based on timestamp information in the report.

45. The method of claim 44, wherein the other network node is a network node controlling the cell in which the triggering event occurred, or a network node controlling the cell in which the wireless device was operating prior to the triggering event occurring.

46. The method of claim 44, wherein the report indicates that the wireless device was operating in a cell of a first type (terrestrial or non-terrestrial) when the triggering event occurred, and the other network node is identified in the report as the last network node operating a cell of the second type (terrestrial or non-terrestrial) in which the wireless device was operating prior to the triggering event occurring.

47. The method of claim 40, wherein the method further comprises classifying a failure event for the wireless device based on the information.

48. The method of claim 47, wherein said classifying is based on an indication, in the information, of when the triggering event occurred, with respect to an end of service time for the serving cell in which the triggering event occurred, or is based on an indication of whether the wireless device was in a coverage zone for the serving cell in which the triggering event occurred, or both.

49. A wireless device, comprising:
radio front-end circuitry; and
processing circuitry, the processing circuitry being operatively coupled to the radio front-end circuitry and configured to:
detect one of one or more pre-determined triggering events;
responsive to the detected triggering event, determine whether the triggering event occurred while the wireless device was operating under non-terrestrial network coverage or under terrestrial network coverage, and/or determining whether the triggering event was due to wireless device mobility or non-terrestrial network cell mobility; and
save, for reporting to the wireless communication network, information corresponding to said determining.

50. A network node, comprising:
interface circuitry configured to communicate with one or more other nodes;
processing circuitry, the processing circuitry being operatively coupled to the interface circuitry and configured to:
receive, from a wireless device, an indication that the wireless device has a report comprising information indicating whether a triggering event at the wireless device occurred while the wireless device was operating in non-terrestrial network coverage;
determine whether to retrieve the report from the wireless device; and
retrieve the report from the wireless device, in response to said determining.
